(19) United States
(12) Patent Application Publication
(10) Pub. No.: US 2024/0003935 A1
(43) Pub. Date: Jan. 4, 2024

(54) Physical Quantity Sensor And Inertial Measurement Unit

(71) Applicant: SEIKO EPSON CORPORATION, Tokyo (JP)

(72) Inventor: Satoru TANAKA, Chino (JP)

(21) Appl. No.: 18/343,025

(22) Filed: Jun. 28, 2023

(30) Foreign Application Priority Data
Jun. 29, 2022 (JP) 2022-104309

(51) Int. Cl. G01P 15/125; G01P 1/00

(52) U.S. Cl. CPC G01P 15/125; G01P 1/00

(57) ABSTRACT

A physical quantity sensor includes a fixed portion, a support beam, a movable body, a first fixed electrode group, and a second fixed electrode group. The support beam has one end coupled to the fixed portion and is provided along a second direction. The movable body is coupled to the other end of the support beam. The first fixed electrode group and the second fixed electrode group are provided at a substrate. The movable body includes a first coupling portion, a first base portion, a first movable electrode group, a second coupling portion, a second base portion, a second movable electrode group, and a mass portion. The first coupling portion is coupled to the other end of the support beam, and the first base portion is coupled to the first coupling portion. The second coupling portion is coupled to the other end of the support beam, and the second base portion is coupled to the second coupling portion.

The present application is based on, and claims priority from JP Application Serial Number 2022-104309, filed Jun. 29, 2022, the disclosure of which is hereby incorporated by reference herein in its entirety.

### BACKGROUND

### 1. Technical Field

The present disclosure relates to a physical quantity sensor and an inertial measurement unit.

### 2. Related Art

JP-A-2021-032819 discloses a physical quantity sensor that detects an acceleration in a Z direction. It is disclosed that, in the physical quantity sensor, a length of one of a plurality of first electrodes along a first direction is smaller than a length of a first conductive portion along the first direction of the first conductive portion. Further, it is disclosed that, in the physical quantity sensor, a length of one of a plurality of second electrodes along the first direction is smaller than a length of a second conductive portion along the first direction of the second conductive portion.

In the physical quantity sensor disclosed in JP-A-2021-032819, when an acceleration is applied in a comb tooth electrode length direction that is not a Z-axis direction that is a detection target direction, there are problems that the same seesaw operation as that performed when an acceleration is applied in the detection axis direction is performed, and sensitivity in other axial directions increases.

### SUMMARY

An aspect of the present disclosure relates to a physical quantity sensor which, when three directions orthogonal to one another are defined as a first direction, a second direction, and a third direction, detects a physical quantity in the third direction, the physical quantity sensor including: a fixed portion fixed to a substrate; a support beam having one end coupled to the fixed portion and provided along the second direction; a movable body coupled to the other end of the support beam; a first fixed electrode group provided at the substrate and disposed in the first direction of the support beam; and a second fixed electrode group provided at the substrate and disposed in a fourth direction opposite to the first direction of the support beam. The movable body includes a first coupling portion coupled to the other end of the support beam and extending from the support beam in the first direction, a first base portion coupled to the first coupling portion and provided along the second direction, a first movable electrode group provided at the first base portion and facing the first fixed electrode group in the second direction, a second coupling portion coupled to the other end of the support beam and extending from the support beam in the fourth direction, a second base portion coupled to the second coupling portion and provided along the second direction, a second movable electrode group provided at the second base portion and facing the second fixed electrode group in the second direction, and a mass portion coupled to the first coupling portion and provided at a first direction side of the first movable electrode group.

Another aspect of the present disclosure relates to an inertial measurement unit including the physical quantity sensor described above and a control unit configured to perform control based on a detection signal output from the physical quantity sensor.

### BRIEF DESCRIPTION OF THE DRAWINGS

FIG. 1 illustrates a configuration example of a physical quantity sensor according to an embodiment.

FIG. 2 is a perspective view of the physical quantity sensor according to the embodiment.

FIG. 3 is a perspective view of a detection part.

FIG. 4 is a diagram illustrating an operation of the detection part.

FIG. 5 is an explanatory diagram illustrating influence of an acceleration in an XY plane on a movable body in the embodiment.

FIG. 6 is an explanatory diagram illustrating influence of the acceleration in the XY plane on the movable body when the embodiment is not applied.

FIG. 7 is a perspective view illustrating another configuration example of a probe electrode.

FIG. 8 is a diagram illustrating an operation of the detection part.

FIG. 9 is a plan view of a first detailed example of the embodiment.

FIG. 10 is a perspective view of the first detailed example of the embodiment.

FIG. 11 is a plan view of a second detailed example of the embodiment.

FIG. 12 is a perspective view of a detection part in the second detailed example.

FIG. 13 is another perspective view of the detection part in the second detailed example.

FIG. 14 is a diagram illustrating an operation of the detection part in the second detailed example.

FIG. 15 is a perspective view of a detection part in a third detailed example.

FIG. 16 is another perspective view of the detection part in the third detailed example.

FIG. 17 is a diagram illustrating an operation of the detection part in the third detailed example.

FIG. 18 is a plan view of a first modification of the embodiment.

FIG. 19 is a plan view of a second modification of the embodiment.

FIG. 20 is an exploded perspective view illustrating a schematic configuration of an inertial measurement unit including a physical quantity sensor.

FIG. 21 is a perspective view of a circuit board of the physical quantity sensor.

### DESCRIPTION OF EXEMPLARY EMBODIMENTS

Hereinafter, an embodiment will be described. The embodiment to be described below does not unduly limit contents described in the claims. All configurations described in the embodiment are not necessarily essential constituent elements.

### 1. Physical Quantity Sensor

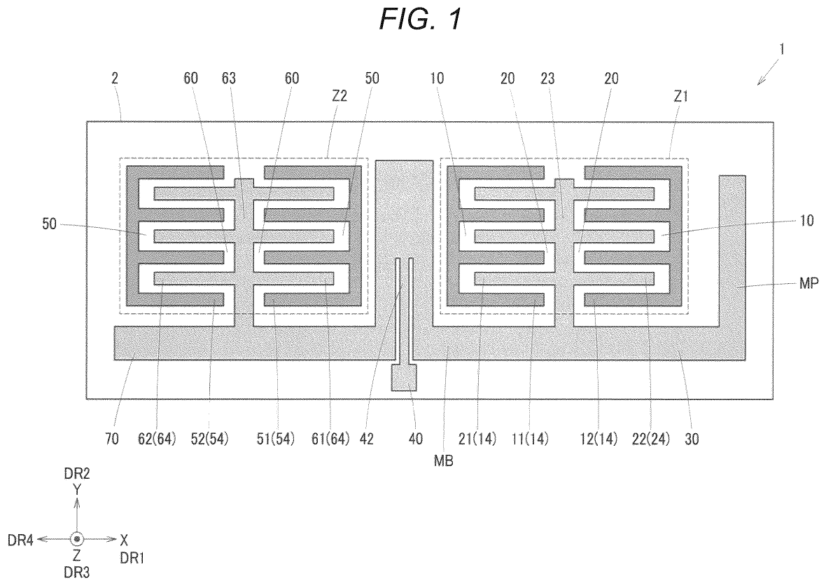

A physical quantity sensor 1 of the embodiment will be described using an acceleration sensor that detects an acceleration in a vertical direction as an example. FIG. 1 is a plan view of the physical quantity sensor 1 of the embodiment in a plan view in a direction orthogonal to a substrate 2. The physical quantity sensor 1 is a micro electro mechanical system (MEMS) device, and is, for example, an inertial sensor.

In FIG. 1 and FIGS. 2 to 19 to be described later, for convenience of description, dimensions of respective members, intervals between the members, and the like are schematically illustrated, and not all the components are illustrated. For example, an electrode wiring, an electrode terminal, and the like are not illustrated. In the following description, a case where a physical quantity detected by the physical quantity sensor 1 is an acceleration will be mainly described as an example. The physical quantity is not limited to the acceleration, and may be another physical quantity such as a velocity, pressure, displacement, a posture, an angular velocity, or gravity, and the physical quantity sensor 1 may be used as a pressure sensor, a MEMS switch, or the like. In FIG. 1, directions orthogonal to one another are defined as a first direction DR1, a second direction DR2, and a third direction DR3. The first direction DR1, the second direction DR2, and the third direction DR3 are, for example, an X-axis direction, a Y-axis direction, and a Z-axis direction, respectively, but are not limited thereto. For example, the third direction DR3 corresponding to the Z-axis direction is, for example, a direction orthogonal to the substrate 2 of the physical quantity sensor 1, and is, for example, the vertical direction. A direction opposite to the third direction DR3 is defined as a fifth direction DR5. The first direction DR1 corresponding to the X-axis direction and the second direction DR2 corresponding to the Y-axis direction are directions orthogonal to the third direction DR3, and an XY plane that is a plane along the first direction DR1 and the second direction DR2 is, for example, along a horizontal plane. A direction opposite to the first direction DR1 is defined as a fourth direction DR4, and the fourth direction is, for example, a −X-axis direction. The term “orthogonal” includes not only a case of intersecting at 90° but also a case of intersecting at an angle slightly deviated from 90°.

The substrate 2 is, for example, a silicon substrate made of semiconductor silicon or a glass substrate made of a glass material such as borosilicate glass. However, a constituent material of the substrate 2 is not particularly limited, and a quartz substrate, a silicon on insulator (SOI) substrate, or the like may be used.

As illustrated in FIG. 1, the physical quantity sensor 1 of the embodiment includes a fixed portion 40, a support beam 42, a movable body MB, a first fixed electrode group 10, and a second fixed electrode group 50. The movable body MB includes a first coupling portion 30, a first base portion 23, a first movable electrode group 20, a second coupling portion 70, a second base portion 63, a second movable electrode group 60, and a mass portion MP. The first fixed electrode group 10 includes a plurality of first fixed electrodes 11 and 12, and the second fixed electrode group 50 includes a plurality of second fixed electrodes 51 and 52. The first movable electrode group 20 includes a plurality of first movable electrodes 21 and 22, and the second movable electrode group 60 includes a plurality of second movable electrodes 61 and 62.

As indicated by a broken line frame in FIG. 1, the physical quantity sensor 1 includes a detection part Z1 and a detection part Z2, and the detection parts detect a physical quantity such as an acceleration in a direction along the third direction DR3 that is the Z-axis direction. The detection parts Z1 and Z2 are provided at a first direction DR1 side and a fourth direction DR4 side of the support beam 42, respectively, in a plan view.

The detection part Z1 provided at the first direction DR1 side of the support beam 42 includes the first fixed electrode group 10 and the first movable electrode group 20. The detection part Z2 provided at the fourth direction DR4 side of the support beam 42 includes the second fixed electrode group 50 and the second movable electrode group 60.

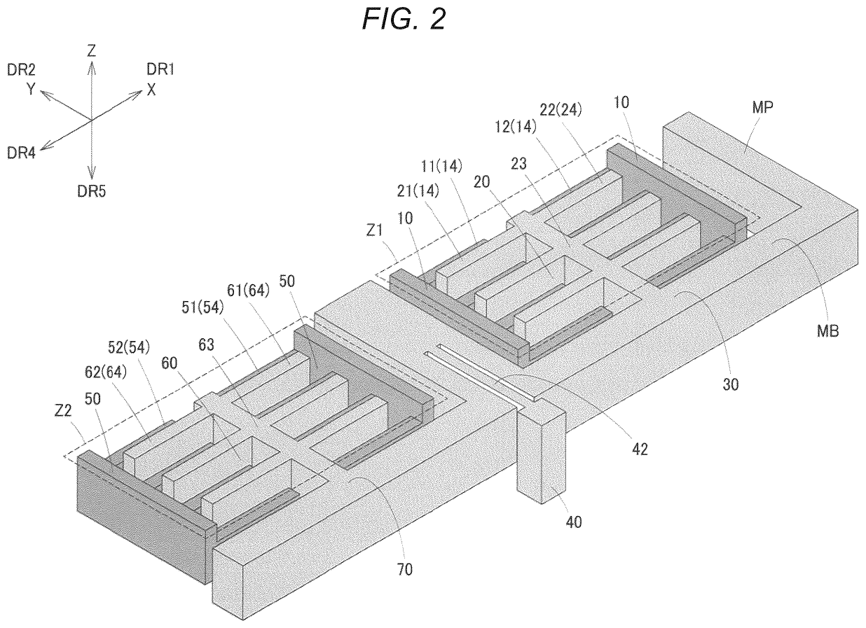

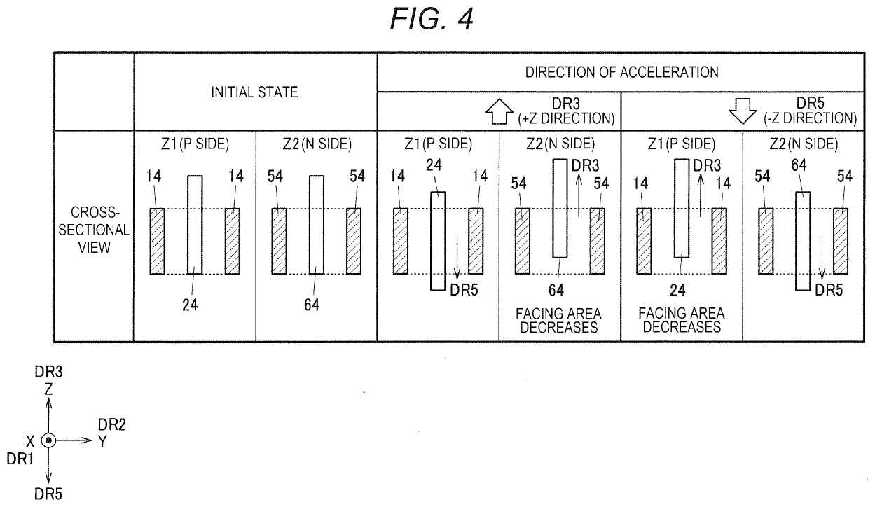

FIG. 2 is a perspective view of the physical quantity sensor 1 of the embodiment. The fixed portion 40 is provided at the substrate 2 as illustrated in FIG. 2. The fixed portion 40 fixes one end of the support beam 42 to the substrate 2 via the fixed portion 40. The other end of the support beam 42 is coupled to the first coupling portion 30 and the second coupling portion 70 of the movable body MB. In this way, the fixed portion 40 couples the movable body MB to the substrate 2 via the support beam 42. The fixed portion 40 serves as an anchor for a seesaw movement of the movable body MB to be described later with reference to FIG. 4.

The support beam 42 applies a restoring force in the seesaw movement of the movable body MB. As illustrated in FIG. 2, the one end of the support beam 42 is coupled to a part of the fixed portion 40. The other end of the support beam 42 is coupled to the first coupling portion 30 and the second coupling portion 70. In this way, the support beam 42 couples the fixed portion 40 and the movable body MB. The support beam 42 is, for example, a torsion spring. As illustrated in FIG. 1, the support beam 42 is provided such that, for example, the second direction DR2 is a longitudinal direction thereof in the plan view. The support beam 42 has a small thickness in the first direction DR1, and is bent in response to the movement of the movable body MB. Then, the movable body MB is twisted, for example, on the Y axis that is the second direction DR2, thereby generating a restoring force in the seesaw movement of the movable body MB. As described above, in the embodiment, the support beam 42 is a torsion spring twisted with the second direction DR2 as a rotation axis. In this way, the movable body MB can perform a swing movement with the second direction DR2 as a rotation axis.

The movable body MB swings, for example, around the rotation axis extending along the second direction DR2. That is, the movable body MB performs the seesaw movement by using torsion of the support beam 42 described above as a restoring force in a rotational movement around the second direction DR2. The physical quantity is detected using the first movable electrode group 20 and the second movable electrode group 60 of the movable body MB as probe electrodes.

The first coupling portion 30 couples the first base portion 23 and the other end of the support beam 42 that is not coupled to the fixed portion 40. The second coupling portion 70 couples the other end of the support beam 42 and the second base portion 63. Here, as illustrated in FIG. 2, the first coupling portion 30 and the second coupling portion 70 are coupled to each other at the other end of the support beam 42, and are integrated with each other to some midpoint. In the plan view, the first coupling portion 30 and the second coupling portion 70 separate from each other so as to surround the support beam 42 from the first direction DR1 side and a second direction DR2 side, the first coupling portion 30 extends to the first direction DR1 side of the support beam 42, and the second coupling portion 70 extends to the fourth direction DR4 side of the support beam 42. In this way, the first coupling portion 30 extends to the first direction DR1 side of the support beam 42, and is coupled to the first base portion 23 at the first direction DR1 side of the support beam 42. The second coupling portion 70 extends to the fourth direction DR4 side of the support beam 42, and is coupled to the second base portion 63 at the fourth direction DR4 side of the support beam 42. In this way, the first coupling portion 30 couples the first base portion 23 so that the first base portion 23 is at a fixed distance from the support beam 42 serving as a rotation axis of the seesaw movement of the movable body MB, and the second coupling portion 70 couples the second base portion 63 so that the second base portion 63 is at the fixed distance from the support beam 42.

The first base portion 23 forms a base portion of the first movable electrode group 20. That is, in the plan view, the plurality of first movable electrodes 22 extend to the first direction DR1 side of the first base portion 23 with the first base portion 23 as the base portion. The plurality of first movable electrodes 21 extend to the fourth direction DR4 side of the first base portion 23 with the first base portion 23 as the base portion. As illustrated in FIG. 1, the first coupling portion 30 extends to the first direction DR1 side from the support beam 42 serving as the rotation axis, and the first base portion 23 is provided so as to extend to the second direction DR2 side from the first coupling portion 30 at a position at the fixed distance from the rotation axis.

The second base portion 63 forms a base portion of the second movable electrode group 60. In the detection part Z2, the second base portion 63 plays the same role as the first base portion 23 of the detection part Z1. That is, in the plan view, the plurality of second movable electrodes 61 extend from the second base portion 63 to the first direction DR1 side, and the plurality of second movable electrodes 62 extend from the second base portion 63 to the fourth direction DR4 side. The second base portion 63 is provided so as to extend from the second coupling portion 70 to the second direction DR2 side, at a position at the fixed distance from the support beam 42 serving as the rotation axis at the fourth direction DR4 side.

With such a configuration, the first base portion 23, together with the first coupling portion 30, couples the first movable electrode group 20 so as to have the fixed distance from the rotation axis of the movable body MB in the seesaw movement. The second base portion 63, together with the second coupling portion 70, couples the second movable electrode group 60 so as to have the fixed distance from the rotation axis of the seesaw movement.

The first fixed electrode group 10 and the first movable electrode group 20 are probe electrodes in the detection part Z1. The first fixed electrode group 10 is a probe electrode fixed to the substrate, and the first movable electrode group 20 is a probe electrode movable integrally with the movable body MB. The physical quantity can be detected by the first fixed electrode group 10 and the first movable electrode group 20.

The first fixed electrode group 10 is fixed to the substrate 2 by a fixing portion. As illustrated in FIGS. 1 and 2, the first fixed electrode group 10 is provided separately at the first direction DR1 side and the fourth direction DR4 side of the first base portion 23. At the first direction DR1 side of the first base portion 23, the first fixed electrodes 12 having a comb tooth shape are provided extending to the fourth direction DR4 side. At the fourth direction DR4 side of the first base portion 23, the first fixed electrodes 11 having a comb tooth shape are provided extending to the first direction DR1 side.

The first movable electrode group 20 includes the comb teeth-shaped first movable electrodes 21 extending to the fourth direction DR4 side of the first base portion 23, and the comb teeth-shaped first movable electrodes 22 extending to the first direction DR1 side of the first base portion 23.

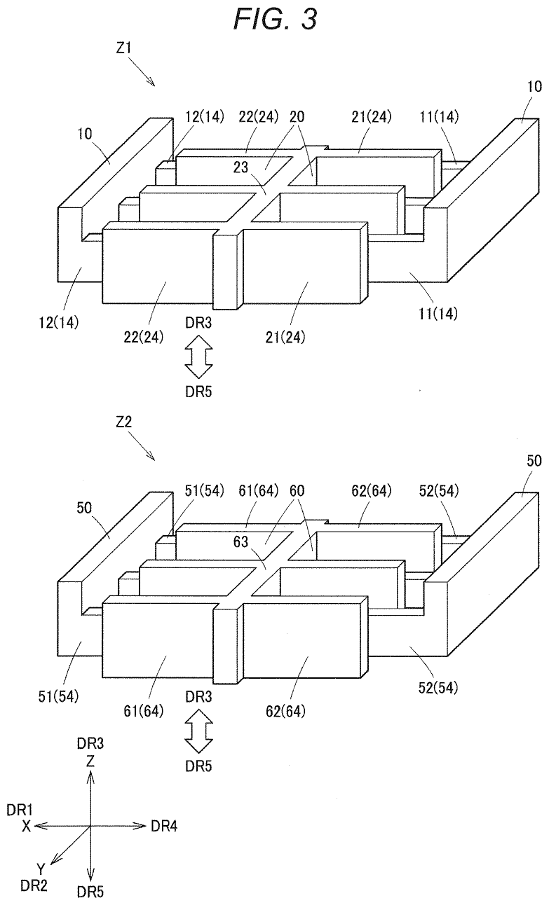

FIG. 3 is a perspective view illustrating a configuration of probe electrodes in the detection part Z1 and the detection part Z2. The upper part of FIG. 3 shows a shape and a positional relationship of the first fixed electrode group 10 and the first movable electrode group 20 in the detection part Z1. In the detection part Z1, the first movable electrodes 21 are alternately provided with the first fixed electrodes 11 so as to face the first fixed electrodes 11 in the second direction DR2, and the first movable electrodes 22 are also alternately provided with the first fixed electrodes 12 so as to face the first fixed electrodes 12 in the second direction DR2. In the following description, the first fixed electrodes 11 and 12 of the first fixed electrode group 10 are not distinguished from each other and are collectively referred to as a first fixed electrode 14. Similarly, the first movable electrodes 21 and 22 of the first movable electrode group 20 are collectively referred to as a first movable electrode 24. Focusing on a thickness of each electrode in the third direction DR3, a thickness of the first movable electrodes 21 and 22 is larger than a thickness of the first fixed electrodes 11 and 12. Here, the thickness is not limited to, for example, a physical thickness of an element obtained by measuring a cross section thereof using a scanning electron microscope (SEM) or the like, and includes a film thickness of a thin film estimated based on optical characteristics such as a refractive index thereof. Positions of ends of the first movable electrodes 21 and 22 and the first fixed electrodes 11 and 12 in the fifth direction DR5 are the same. Therefore, ends of the first movable electrodes 21 and 22 on a third direction DR3 side are located at the third direction DR3 side with respect to ends of the first fixed electrodes 11 and 12 on the third direction DR3 side. In other words, in the detection part Z1, a one-side offset structure is implemented in which the ends of the first movable electrodes 21 and 22 protrude further than the ends of the first fixed electrodes 11 and 12 at the third direction DR3 side, and the ends of the first movable electrodes 21 and 22 are flush with the ends of the first fixed electrodes 11 and 12 at the fifth direction DR5 side.

The lower part of FIG. 3 shows a shape and a positional relationship of the second fixed electrode group and the second movable electrode group 60 in the detection part Z2. Similarly to the detection part Z1 illustrated in the upper part of FIG. 3, the detection part Z2 also has a probe electrode structure of a one-side offset structure. The second fixed electrodes 51 and 52 and the second movable electrodes 61 and 62 in the detection part Z2 correspond to the first fixed electrodes 11 and 12 and the first movable electrodes 21 and 22 in the detection part Z1, respectively, and a thickness of the second movable electrodes 61 and 62 is larger than a thickness of the second fixed electrodes 51 and 52. In the one-side offset structure, at the third direction DR3 side, ends of the second movable electrodes 61 and 62 protrude further than ends of the second fixed electrodes 51 and 52. In the following description, the second fixed electrodes 51 and 52 of the second fixed electrode group 50 are not distinguished from each other and are collectively referred to as a second fixed electrode 54. Similarly, the second movable electrodes 61 and 62 of the second movable electrode group 60 are collectively referred to as a second movable electrode 64. In addition, as in the case of the detection part Z1, the number of comb tooth electrodes of the second fixed electrodes 51 and 52 and the second movable electrodes 61 and 62 can be freely provided.

That is, in the embodiment, positions of the first movable electrode group 20 and the first fixed electrode group 10 on a back surface side coincide with each other in an initial state, and positions of the second movable electrode group 60 and the second fixed electrode group 50 on the back surface side coincide with each other in the initial state.

In this way, after electrode materials of the first movable electrode group 20, the first fixed electrode group 10, the second movable electrode group 60, and the second fixed electrode group 50 are formed, the comb tooth electrodes can be collectively formed by the same machining process, and the manufacturing process is simplified.

The mass portion MP serves as a mass portion in the seesaw movement of the movable body MB. As illustrated in FIG. 1, the mass portion MP extends to the second direction DR2 side from a tip end portion of the first coupling portion 30 extending in the first direction DR1 in the plan view. In addition, as illustrated in FIG. 2, the mass portion MP has a shape of surrounding the detection part Z1 at the first direction DR1 side. That is, in the embodiment, the mass portion MP extends along the second direction DR2 from the first coupling portion 30, at the first direction DR1 side of the first movable electrode group 20. In the physical quantity sensor 1 of the embodiment, the movable body MB performs the seesaw movement integrally with the first coupling portion 30 and the second coupling portion 70 across the rotation axis. For this reason, when a moment of inertia of the components on the first direction DR1 side and a moment of inertia of the components on the fourth direction DR4 side are balanced with respect to the rotation axis, torques generated in the components are balanced, and the entire movable body MB cannot swing around the rotation axis. Therefore, the mass portion MP is provided in the components on the first direction side of the rotation axis, and the moments of inertia are configured to be asymmetric on both sides sandwiching the rotation axis of the movable body MB, so that the movable body MB can be inclined with respect to an acceleration. In the embodiment, the mass portion MP is provided at the first direction DR1 side, and may be alternatively provided at the fourth direction DR4 side.

FIG. 4 is a diagram illustrating operations of the detection parts Z1 and Z2 of the physical quantity sensor 1 according to the embodiment. Specifically, movement of the probe electrodes with respect to a direction of an acceleration when the acceleration occurs from an initial state is shown in a schematic view of a cross section as viewed from the first direction DR1. Here, the initial state refers to a stationary state, that is, a state in which no acceleration occurs except for the gravitational acceleration. The detection part Z1 corresponds to a P side of a probe, and the detection part Z2 corresponds to an N side of the probe.

First, in the initial state illustrated at the left part of FIG. 4, the first fixed electrode 14 and the first movable electrode 24 of the detection part Z1 face each other such that parts thereof overlap each other along the third direction DR3. Specifically, the positions of the ends of the first fixed electrodes 14 and the first movable electrodes 24 in the fifth direction DR5 coincide with each other, but the position of the end of the first movable electrode 24 in the third direction DR3 is at the third direction DR3 side with respect to the position of the end of the first fixed electrode 14 in the third direction DR3. In the initial state, the first fixed electrode 14 and the first movable electrode 24 are stationary in a state of partially overlapping each other along the third direction DR3. In addition, the second fixed electrode 54 and the second movable electrode 64 of the detection part Z2 also face each other such that parts thereof overlap each other along the third direction DR3. The end of the second movable electrode 64 in the third direction DR3 is located at the third direction DR3 side with respect to the end of the second fixed electrode 54 in the third direction DR3.

In the embodiment, the thickness of the first movable electrode group 20 in the third direction DR3 is larger than the thickness of the first fixed electrode group 10 in the third direction DR3, and the thickness of the second movable electrode group 60 in the third direction DR3 is larger than the thickness of the second fixed electrode group 50 in the third direction DR3.

In this initial state, a physical quantity obtained by summing up a physical quantity corresponding to a facing area of the first fixed electrode 14 and the first movable electrode 24 in the detection part Z1 and a physical quantity corresponding to a facing area of the second fixed electrode 54 and the second movable electrode 64 in the detection part Z2 is a physical quantity in the initial state. Examples of the physical quantity include a static capacitance.

Next, an operation in a state where an acceleration in the third direction DR3 occurs as illustrated in a center part of FIG. 4 will be described. In the state where the acceleration in the third direction DR3 occurs, the first movable electrode 24 receives an inertial force in a direction opposite to the direction of the acceleration in the detection part Z1. Therefore, the first movable electrode 24 of the detection part Z1 is displaced toward the fifth direction DR5 side, that is, in a −Z direction, and the second movable electrode 64 of the detection part Z2 is displaced in a +Z direction. Accordingly, in the detection part Z1, as illustrated in FIG. 4, the facing area of the first fixed electrode 14 and the first movable electrode 24 is maintained, and in the detection part Z2, the facing area of the second fixed electrode 54 and the second movable electrode 64 decreases. Accordingly, a physical quantity in the third direction DR3 can be detected by detecting a change in a physical quantity due to a decrease in the facing area in the detection part Z2.

On the other hand, as illustrated in the right part of FIG. 4, in a state where an acceleration in the fifth direction DR5 occurs from the initial state, the first movable electrode 24 receives an inertial force in the third direction DR3. Therefore, in the detection part Z1, the first movable electrode 24 is displaced in the third direction DR3, and in the detection part Z2, the second movable electrode 64 is displaced toward the fifth direction DR5 side in a direction opposite to that of the first movable electrode 24. Accordingly, the facing area of the first fixed electrode 14 and the first movable electrode 24 decreases in the detection part Z1, and the facing area of the second fixed electrode 54 and the second movable electrode 64 is maintained in the detection part Z2. Accordingly, a physical quantity in the fifth direction DR5 can be detected by detecting a change in a physical quantity due to a decrease in the facing area in the detection part Z1. When detecting a change in the static capacitance serving as a physical quantity, for example, the static capacitance can be detected by coupling the first fixed electrode 14, the second fixed electrode 54, the first movable electrode 24, and the second movable electrode 64 to a differential amplifier circuit (not shown) via a wiring and a pad.

That is, according to the embodiment, when an acceleration in the third direction DR3 occurs, the facing area of the first fixed electrode group 10 and the first movable electrode group 20 is maintained in the detection part Z1, and the facing area of the second fixed electrode group 50 and the second movable electrode group 60 decreases in the detection part Z2, so that a change in a physical quantity in the third direction DR3 can be detected. In addition, when an acceleration in the fifth direction DR5 occurs, the facing area of the second fixed electrode group 50 and the second movable electrode group 60 is maintained in the detection part Z2, and the facing area of the first fixed electrode group 10 and the first movable electrode group 20 decreases in the detection part Z1, so that a change in a physical quantity in the fifth direction DR5 can be detected.

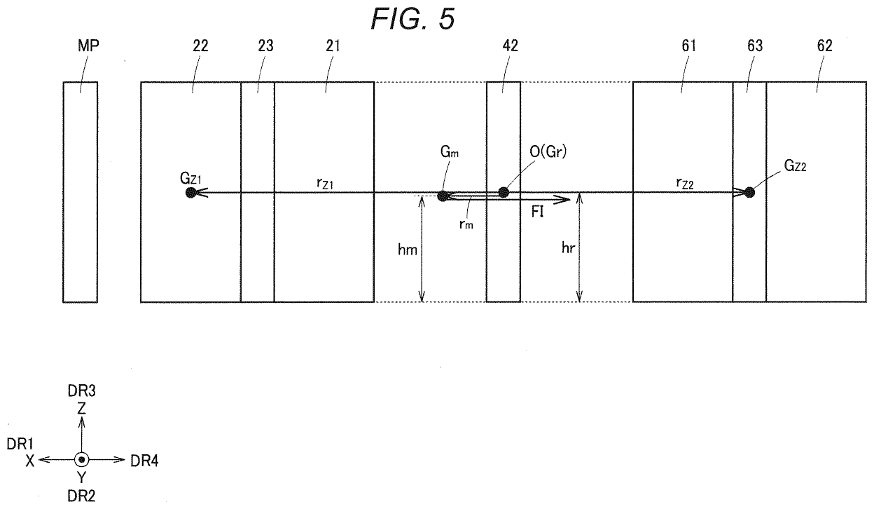

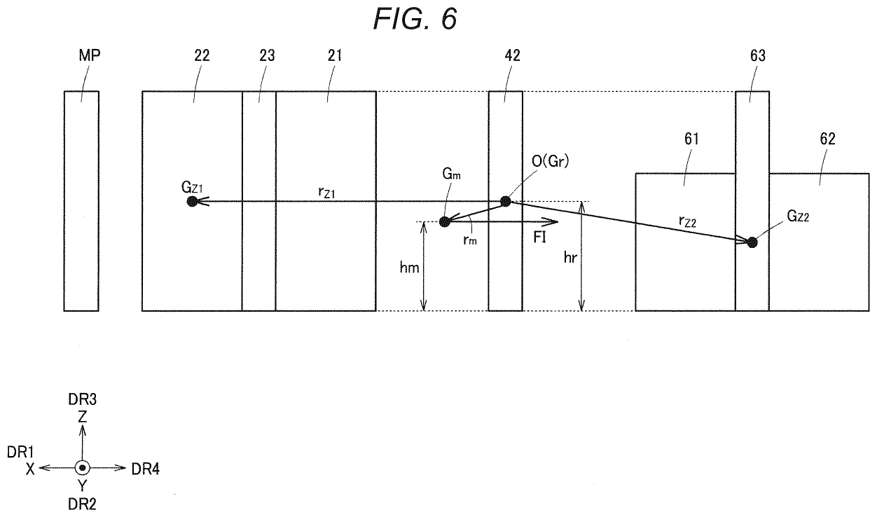

FIGS. 5 and 6 are diagrams illustrating influence exerted on the movable body MB when an acceleration in the XY plane occurs. FIGS. 5 and 6 are schematic cross-sectional views of the physical quantity sensor 1 as viewed from the second direction DR2 side. In FIGS. 5 and 6, the first coupling portion 30, the second coupling portion 70, the fixed portion 40, and the substrate 2 are omitted.

A black circle illustrated in FIG. 5 indicates a gravity center position. For example, Gᵣ indicates a gravity center position of the support beam 42. The gravity center position Gᵣ is also a position corresponding to the rotation axis when the movable body MB performs the seesaw movement, and is an origin O. In the cross-sectional view illustrated in FIG. 5, the gravity center position Gᵣ of the support beam 42 is located at a height of hr with respect to a horizontal plane including an end of the support beam 42 in the fifth direction DR5. The height hr is also a height of a center position of twist when the support beam 42 is twisted, that is, a height of the rotation axis of the movable body MB in the third direction DR3. Here, the height refers to a height in the third direction DR3 with respect to a horizontal plane including the support beam 42 in a state where the movable body MB is horizontal to the XY plane. That is, the height refers to a height in the third direction DR3 with respect to the horizontal plane including the support beam 42 in the stationary state.

G_{Z1} indicates a gravity center position of the first movable electrodes 21 and 22, the first coupling portion 30, the first base portion 23, and the mass portion MP. That is, G_{Z1} indicates a gravity center position of all components located at the first direction DR1 side of the support beam 42 in the movable body MB. G_{Z2} indicates a gravity center position of the second movable electrodes 61 and 62, the second coupling portion 70, and the second base portion 63. That is, G_{Z2} indicates a gravity center position of all components located at the fourth direction DR4 side of the support beam 42 in the movable body MB. Gₘ indicates a gravity center position of the entire movable body MB. Here, unlike the gravity center position G_{Z2}, the gravity center position G_{Z1} is a gravity center position of the components including the mass portion MP farthest from the support beam 42 serving as the rotation axis. Therefore, the gravity center position G_{Z1} exists at a position farther from the origin O on the X axis than the gravity center position G_{Z2} located at the fourth direction DR4 side of the support beam 42. Accordingly, the gravity center position Gₘ of the entire movable body MB is an intermediate position between the gravity center position G_{Z1} and the gravity center position G_{Z2}, and exists at the first direction DR1 side of the support beam 42 in the cross-sectional view as viewed from the second direction DR2. The gravity center position Gₘ is located at a position of hm in height with respect to the horizontal plane including the support beam 42. In the embodiment illustrated in FIG. 5, thicknesses of the components of the movable body MB in the third direction DR3 are equal to each other, and thus heights of the gravity center positions Gₘ, G_{Z1}, and G_{Z2} are equal to each other. Therefore, a relationship hm=hr is established. Accordingly, position vectors rₘ, r_{Z1}, and r_{Z2} from the origin O to the respective gravity center positions are parallel to each other.

The heights of the gravity center positions Gₘ, G_{Z1}, and G_{Z2} described above are substantially equal. For example, in a case of performing etching in a semiconductor manufacturing process, even when etching is performed with the same apparatus and conditions, variations in finished dimensions occur due to the apparatus. Therefore, it is a common practice to perform process management by providing a fixed margin for a target machining dimension. For this reason, the heights of the gravity center positions Gₘ, G_{Z1}, and G_{Z2} are usually not completely equal. Accordingly, regarding the heights of the gravity center positions Gₘ, G_{Z1}, and G_{Z2}, being equal means being substantially equal.

Next, regarding the physical quantity sensor 1 of the embodiment, influence exerted when an acceleration in the XY plane occurs, that is, when an acceleration in a direction perpendicular to the third direction DR3 that is a detection target axis of the physical quantity sensor 1 occurs will be examined. Specifically, when an acceleration in the direction perpendicular to the detection target axis occurs, how the swing movement around the support beam 42 serving as the rotation axis of the movable body MB is affected becomes a problem.

First, considering a case where the direction of the acceleration is the first direction DR1, as illustrated in FIG. 5, an inertial force FI in the fourth direction DR4, which is the opposite direction of the first direction DR1, acts on the gravity center position Gₘ of the movable body MB. The inertial force FI can be expressed by a vector (FIₓ, 0, 0).

Here, a torque T is generally expressed by an outer product of a position vector (x, y, z) and a force vector (Fₓ, F_{y}, F_{z}) as in the following formula (1).

$$\vec{T} = ( \begin{matrix}x \\ y \\ z\end{matrix} ) \times ( \begin{matrix}{F}_{x} \\ {F}_{y} \\ {F}_{Z}\end{matrix} ) = ( \begin{matrix}{yF}_{z} - {zF}_{y} \\ {zF}_{x} - {xF}_{Z} \\ {xF}_{y} - {yF}_{x}\end{matrix} ) \qquad ( 1 )$$

Accordingly, when a position vector from the origin O of the movable body MB is set as rₘ=(rₘₓ, 0, 0), a torque generated in a rotational physical system including the movable body MB is obtained as (0, 0, 0) by substituting rₘ=(rₘₓ, 0, 0) and the inertial force vector FI=(FIₓ, 0, 0) into formula (1). That is, even when the acceleration in the first direction DR1 occurs, the swing movement of the movable body MB around the support beam 42 serving as the rotation axis is not affected.

Here, a problem of the physical quantity sensor disclosed in the JP-A-2021-032819 will be examined. A physical quantity sensor illustrated in FIG. 6 has a structure in which a thickness of a movable electrode is small as in JP-A-2021-032819. Specifically, the support beam 42 and the second movable electrodes 61 and 62 have different thicknesses in the third direction DR3. Therefore, a position vector r_{Z2} from the origin O to the gravity center position G_{Z2} is inclined to the fifth direction DR5 side with respect to the XY plane. Accordingly, the position vector rₘ to the gravity center position Gₘ of the movable body MB is inclined by an angle θ with respect to the XY plane.

Accordingly, the position vector rₘ is expressed using a vector (rₘₓ, 0, r_{mz}). Note that r_{mz} of a Z coordinate is a negative value. In this case, when the acceleration in the first direction DR1 occurs and the inertial force FI directed toward the fourth direction DR4 side is applied, if the position vector rₘ=(rₘₓ, 0, r_{mz}) and the inertial force FI=(FIₓ, 0, 0) are substituted into formula (1), the torque T generated in the rotational physical system including the movable body MB is obtained as formula (2).

$$\vec{T} = ( \begin{matrix}{r}_{mx} \\ 0 \\ {r}_{mz}\end{matrix} ) \times ( \begin{matrix}{FI}_{x} \\ 0 \\ 0\end{matrix} ) = ( \begin{matrix}0 \\ {r}_{mz} {FI}_{x} \\ 0\end{matrix} ) = ( \begin{matrix}0 \\ {r}_{m} {FI}_{x} sin θ \\ 0\end{matrix} ) \qquad ( 2 )$$

That is, since r_{mz} is a negative value, the torque T is a vector in a −Y direction. Accordingly, the movable body MB is about to move toward a +Z direction side on a circular trajectory having the Y axis as a rotation axis. Further, since a y component of the torque T obtained by the formula (2) is proportional to sine, the position vector rₘ of the movable body MB is inclined in the fifth direction DR5 and the y component of the torque T increases as the thickness of the second movable electrodes 61 and 62 in the third direction decreases. That is, as the thickness of the second movable electrodes 61 and 62 in the third direction decreases, the movable body MB receives a stronger force directed to the +Z direction side on the circular trajectory having the Y axis as a rotation axis. As described above, in the configuration disclosed in JP-A-2021-032819, by changing the thickness of the second movable electrodes 61 and 62 and the first movable electrodes 21 and 22 in the third direction DR3, or the thickness of the second movable electrodes 61 and 62 and the support beam 42 in the third direction DR3, the position vector to the gravity center position G_{Z1} of the movable body MB deviates from the XY plane, which leads to detection of an unnecessary acceleration with respect to the acceleration in the first direction DR1. When sensitivity in other axial directions increases in the physical quantity sensor, a physical quantity other than the physical quantity to be detected is detected as the physical quantity to be detected. Therefore, it is desired to reduce the sensitivity in other axial directions as much as possible.

In the physical quantity sensor 1 disclosed in JP-A-2021-032819, an SN ratio of an output signal can be improved by reducing the thickness of the first movable electrodes 21 and 22 or the second movable electrodes 61 and 62 in the third direction DR3 to reduce the facing area of the probe electrodes. However, according to this configuration, as described above, the sensitivity in other axial directions of the physical quantity sensor increases, and it becomes difficult to detect the physical quantity with high accuracy.

In this regard, in the embodiment, by reducing the facing area of the probe electrodes, it is possible to obtain an advantage of improving the SN ratio of the output signal, and at the same time, by making the height of the gravity center position Gᵣ of the support beam 42 and the height of the gravity center position Gₘ of the movable body MB equal to each other, it is possible to reduce the sensitivity in other axial directions.

That is, in the embodiment, the thicknesses of the first base portion 23, the second base portion 63, the first coupling portion 30, and the second coupling portion 70 in the third direction DR3 are equal to the thickness of the support beam 42 in the third direction DR3.

In this way, the height hr of the rotation center of the support beam 42 in the third direction DR3 can be made equal to the height hm of the gravity center position Gₘ of the movable body MB in the third direction DR3. Therefore, in the physical quantity sensor 1, the position vector rₘ from the support beam 42, which is the rotation axis of the movable body MB, to the gravity center position Gₘ of the movable body MB can be made horizontal. Accordingly, it is possible to prevent the movable body MB from swinging with the support beam 42 as the rotation axis when an acceleration in a direction other than the third direction DR3 occurs.

A gravity center refers to a center position of mass distribution in a target component. When mass distribution in components is not uniform, a gravity center position is not necessarily a center position of the components. In the embodiment, regardless of the thickness and shape of the components, it is sufficient that the height hm of the gravity center position Gₘ of the movable body MB and the height hr of the gravity center position G r of the support beam 42 coincide with each other. For example, even when the support beam 42, the first movable electrodes 21 and 22, the second movable electrodes 61 and 62, and the mass portion MP do not have the magnitude relationship as illustrated in FIG. 5, it is sufficient that positions of the gravity center position Gₘ and the gravity center position Gᵣ coincide with each other in the third direction DR3.

That is, the physical quantity sensor 1 of the embodiment includes the fixed portion 40, the support beam 42, the movable body MB, the first fixed electrode group 10, and the second fixed electrode group 50. The fixed portion 40 is fixed to the substrate 2, the support beam 42 has the one end coupled to the fixed portion 40 and is provided along the second direction DR2, and the movable body MB is coupled to the other end of the support beam 42. The first fixed electrode group 10 is provided at the substrate 2 and disposed in the first direction DR1 of the support beam 42, and the second fixed electrode group 50 is provided at the substrate 2 and disposed in the fourth direction DR4 opposite to the first direction DR1 of the support beam 42. The movable body MB includes the first coupling portion 30, the first base portion 23, the first movable electrode group 20, the second coupling portion 70, the second base portion 63, the second movable electrode group 60, and the mass portion MP. The first coupling portion 30 is coupled to the other end of the support beam 42 and extends from the support beam 42 in the first direction DR1. The first base portion 23 is coupled to the first coupling portion 30 and is provided along the second direction DR2. The first movable electrode group 20 is provided at the first base portion 23 and faces the first fixed electrode group 10 in the second direction DR2. The second coupling portion 70 is coupled to the other end of the support beam 42 and extends from the support beam 42 in the fourth direction DR4. The second base portion 63 is coupled to the second coupling portion 70 and is provided along the second direction DR2. The second movable electrode group 60 is provided at the second base portion 63 and faces the second fixed electrode group 50 in the second direction DR2. The mass portion MP is coupled to the first coupling portion 30 and is provided at the first direction DR1 side of the first movable electrode group 20.

In this way, with respect to an acceleration in the third direction DR3, the support beam 42 is twisted, and thus the movable body MB can perform the swing movement with the support beam 42 as the rotation axis. Due to the swing movement of the movable body MB, the facing area of the first fixed electrode group 10 and the first movable electrode group 20 changes, and the facing area of the second fixed electrode group 50 and the second movable electrode group 60 also changes. Accordingly, a change in a physical quantity can be detected based on the change in the facing area of the probe electrodes.

In the embodiment, hm=hr, where hm is the height of the gravity center position of the movable body MB in the third direction DR3 and hr is the height of the rotation center of the support beam 42 in the third direction DR3.

According to the embodiment, the height hm of the gravity center position Gₘ of the movable body MB is equal to the height hr of the gravity center position Gᵣ of the support beam 42. Therefore, the torque T that moves the movable body MB in the third direction DR3 is not generated with respect to the inertial force FI associated with an acceleration in the first direction DR1 and the fourth direction DR4 that are directions other than the third direction DR3. Accordingly, the sensitivity in other axial directions of the physical quantity sensor 1 is reduced, and a physical quantity can be detected with high accuracy. In addition, by reducing the thickness of the first movable electrode group 20 and the second movable electrode group 60 in the third direction DR3 so that the height hm and the height hr are equal to each other, it is possible to maintain the advantage of improving the SN ratio of the output signal disclosed in JP-A-2021-032819.

In the embodiment, the thicknesses of the first movable electrode group 20 and the second movable electrode group 60 in the third direction DR3 are equal to the thickness of the support beam 42 in the third direction DR3.

In this way, since the thicknesses of the first movable electrode group 20 and the second movable electrode group 60 in the third direction DR3 are equal to each other, it is simplified to form these electrodes by batch processing in the same machining process.

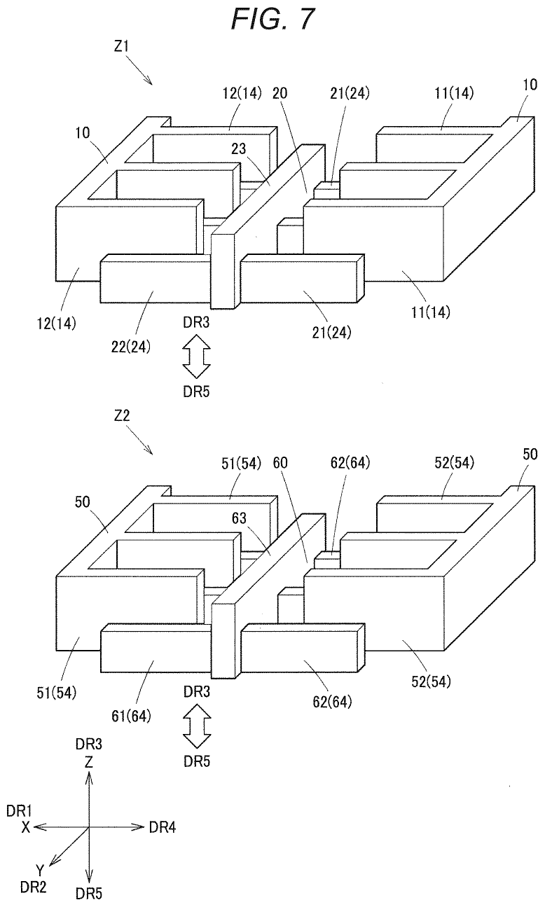

FIG. 7 illustrates an example in which shapes of the probe electrodes shown in FIG. 3 are changed. In the example of FIG. 3, the thickness of the first movable electrodes 21 and 22 is different from the thickness of the second movable electrodes 61 and 62. Specifically, in the example illustrated in FIG. 7, as illustrated in an upper part of FIG. 7, in the detection part Z1, a thickness of the first movable electrodes 21 and 22 in the third direction DR3 is smaller than a thickness of the first fixed electrodes 11 and 12 in the third direction DR3. As illustrated in the lower part of FIG. 7, in the detection part Z2, a thickness of the second movable electrodes 61 and 62 in the third direction DR3 is smaller than a thickness of the second fixed electrodes 51 and 52 in the third direction DR3. That is, in the example illustrated in FIG. 3, a magnitude relationship between the thickness of the first fixed electrode group 10 in the third direction DR3 and the thickness of the first movable electrode group 20 in the third direction DR3 is reversed. A magnitude relationship between the thickness of the second fixed electrode group 50 in the third direction DR3 and the thickness of the second movable electrode group 60 in the third direction DR3 is also reversed.

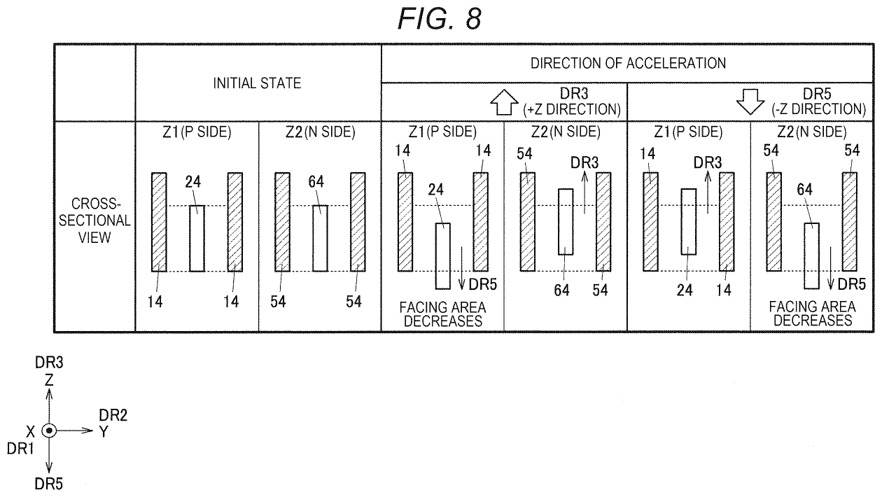

FIG. 8 is a diagram illustrating operations of the detection parts Z1 and Z2 of the physical quantity sensor 1 when the shapes of the probe electrodes shown in FIG. 7 are adopted. Basic operations are as described with reference to FIG. 3, and what is different is that which of the detection parts Z1 and Z2 detects a change in a physical quantity when an acceleration occurs. Specifically, when an acceleration in the third direction DR3 occurs, a facing area of the probe electrodes in the detection part Z1 decreases as illustrated in a center column of FIG. 8, thereby detecting a physical quantity. In addition, when an acceleration in the fifth direction DR5 occurs, the facing area of the probe electrodes in the detection part Z2 decreases as illustrated in a right column of FIG. 8, thereby detecting a physical quantity.

That is, in the embodiment, the thickness of the first movable electrode group 20 in the third direction DR3 is smaller than the thickness of the first fixed electrode group 10 in the third direction DR3, and the thickness of the second movable electrode group 60 in the third direction DR3 is smaller than the thickness of the second fixed electrode group 50 in the third direction DR3.

In this way, when the acceleration in the third direction DR3 occurs, the facing area of the second fixed electrode group 50 and the second movable electrode group 60 is maintained in the detection part Z2, and the facing area of the first fixed electrode group 10 and the first movable electrode group 20 decreases in the detection part Z1, so that a change in the physical quantity in the third direction DR3 can be detected. In addition, when the acceleration in the fifth direction DR5 occurs, the facing area of the first fixed electrode group 10 and the first movable electrode group 20 is maintained in the detection part Z1, and the facing area of the second fixed electrode group 50 and the second movable electrode group 60 decreases in the detection part Z2, so that a change in the physical quantity in the fifth direction DR5 can be detected.

In the embodiment, a torsion spring is used for the support beam 42. Accordingly, since rigidity of the support beam 42 can be adjusted by adjusting the thickness thereof in the third direction DR3, sensitivity can be easily increased without increasing area thereof, and a size thereof can be reduced. In addition, since the second direction DR2, which is a length direction of the torsion spring, and the first direction DR1, which is a length direction of the comb tooth, are orthogonal to each other, comb tooth lengths of the first movable electrodes 21 and 22 and the second movable electrodes 61 and 62 do not become long, and it is possible to improve impact resistance and prevent a defect such as sticking between the electrodes.

Further, in the embodiment, longitudinal directions of the first base portion 23 and the second base portion 63 are the same as the second direction DR2 that is the rotation axis. In this way, even when a swing movement in an in-plane rotation direction of the substrate 2 occurs, a vibration frequency of the swing movement and a frequency in a detection mode of the physical quantity sensor 1 can be separated, and a resonance phenomenon can be prevented. Accordingly, it is possible to prevent vibration caused in a swing mode from interfering with the detection of the physical quantity sensor 1, and it is also possible to prevent an increase in the sensitivity in other axial directions.

### 2. Detailed Configuration Example

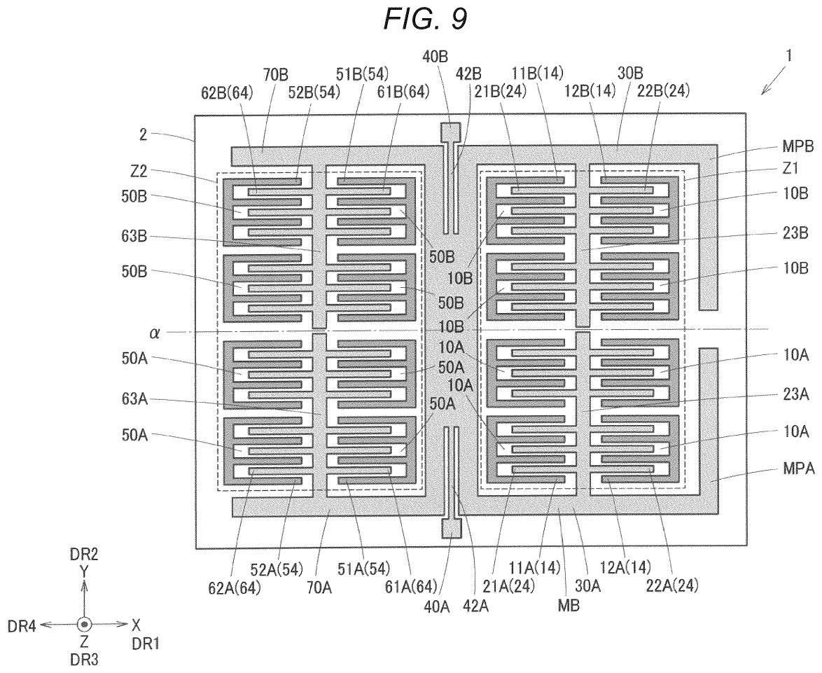

FIG. 9 is a plan view of a first detailed example of the embodiment. The first detailed example is a physical quantity sensor having an area-changing structure, whose area changes due to out-of-plane rotation, as in the configuration example illustrated in FIG. 1, but the movable body MB is coupled to the substrate 2 by two fixed portions of a fixed portion 40A and a fixed portion 40B. The first detailed example has a configuration obtained by expanding the configuration in FIG. 1 to the second direction DR2 side so as to be symmetrical with respect to a one-dot chain line indicated by a in the plan view.

The fixed portion 40A of the first detailed example corresponds to the fixed portion 40 in the configuration example in FIG. 1, and the fixed portion 40B is provided at a position symmetrical to the fixed portion 40A with respect to the one-dot chain line indicated by a in the plan view. A support beam 42B extending from the fixed portion 40B in a direction opposite to the second direction DR2 is provided. From the other end of the support beam 42B that is not coupled to the fixed portion a third coupling portion 30B is provided symmetrically to a first coupling portion 30A, which corresponds to the first coupling portion 30 in the configuration example in FIG. 1, with respect to the one-dot chain line indicated by a. A third base portion 23B is provided symmetrically to a first base portion 23A, which corresponds to the first base portion 23 in the configuration example in FIG. 1, with respect to the one-dot chain line indicated by a. A first fixed electrode group 10A and the like of the first detailed example correspond to the first fixed electrode group 10 and the like in the configuration example in FIG. 1. A first movable electrode group 20A and the like and a mass portion MPA of the first detailed example correspond to the first movable electrode group 20 and the like and the mass portion MP in the configuration example in FIG. 1. A third fixed electrode group 10B and the like, a third movable electrode group 20B and the like, and a mass portion MPB are provided symmetrically to the first fixed electrode group 10A and the like, the first movable electrode group and the like, and the mass portion MPA with respect to the one-dot chain line indicated by a. As described above, in the first detailed example, the detection part Z1 includes a portion including the first fixed electrode group 10A, the first movable electrode group 20A, and the first base portion 23A, and a portion including the third fixed electrode group 10B, the third movable electrode group 20B, and the third base portion 23B.

At the fourth direction DR4 side from the support beams 42A and 42B serving as the rotation axis of the first detailed example, a fourth coupling portion 70B is provided symmetrically to a second coupling portion 70A with respect to the one-dot chain line indicated by a, from the other end of the support beam 42B that is not coupled to the fixed portion 40B. The second coupling portion 70A corresponds to the second coupling portion 70 in the configuration example in FIG. 1. A fourth base portion 63B is provided symmetrically to a second base portion 63A, which corresponds to the second base portion 63 of the configuration example in FIG. 1, with respect to the one-dot chain line indicated by a. A second fixed electrode group 50A and the like of the first detailed example correspond to the second fixed electrode group 50 and the like in the configuration example in FIG. 1. A second movable electrode group 60A and second movable electrodes 61A and 62A of the first detailed example correspond to the second movable electrode group 60 and the second movable electrodes 61 and 62 in the configuration example in FIG. 1. A fourth fixed electrode group 50B, a fourth movable electrode group 60B, and the like are provided symmetrically to the second fixed electrode group 50A, the second movable electrode group 60A, and the like with respect to the one-dot chain line indicated by a. As described above, in the first detailed example, the detection part Z2 includes a portion including the second fixed electrode group 50A, the second movable electrode group 60A, and the second base portion 63A, and a portion including the fourth fixed electrode group 50B, the fourth movable electrode group 60B, and the fourth base portion 63B.

The configuration of the probe electrodes of the first detailed example is similar to the configuration illustrated in FIG. 3. A method of detecting a physical quantity is similar to the method illustrated in FIG. 4. In the detection part Z1, regarding the configuration of the probe electrodes, for example, first fixed electrodes 11A and 12A and third fixed electrodes 11B and 12B have the same thickness in the third direction DR3, and first movable electrodes 21A and 22A and third movable electrodes 21B and 22B have the same thickness in the third direction DR3. In the detection part Z2, second fixed electrodes 51A and 52A and fourth fixed electrodes 51B and 52B have the same thickness in the third direction DR3, and the second movable electrodes 61A and 62A and fourth movable electrodes 61B and 62B have the same thickness in the third direction DR3. The thickness of the first movable electrodes 21A and 22A and the third movable electrodes 21B and 22B in the third direction DR3 is larger than the thickness of the first fixed electrodes 11A and 12A and the third fixed electrodes 11B and 12B in the third direction DR3. The thickness of the second movable electrodes 61A and 62A and the fourth movable electrodes 61B and 62B in the third direction DR3 is larger than the thickness of the second fixed electrodes 51A and 52A and the fourth fixed electrodes 51B and 52B in the third direction DR3. Regarding the thickness of the probe electrodes in the third direction DR3 in the first detailed example, the movable comb tooth electrodes may be thinner than the fixed comb tooth electrodes as illustrated in FIG. 7.

To supplement the first detailed example, the first detailed example has a double seesaw structure, and the detection parts Z1 and Z2 are not dispersedly disposed with respect to the support beams 42A and 42B serving as the rotation axis and are collectively disposed on both sides of the rotation axis. The components are flush with each other at a back surface side. The movable electrode groups, the coupling portions, the base portions, and the support beams have the same thickness in the third direction DR3.

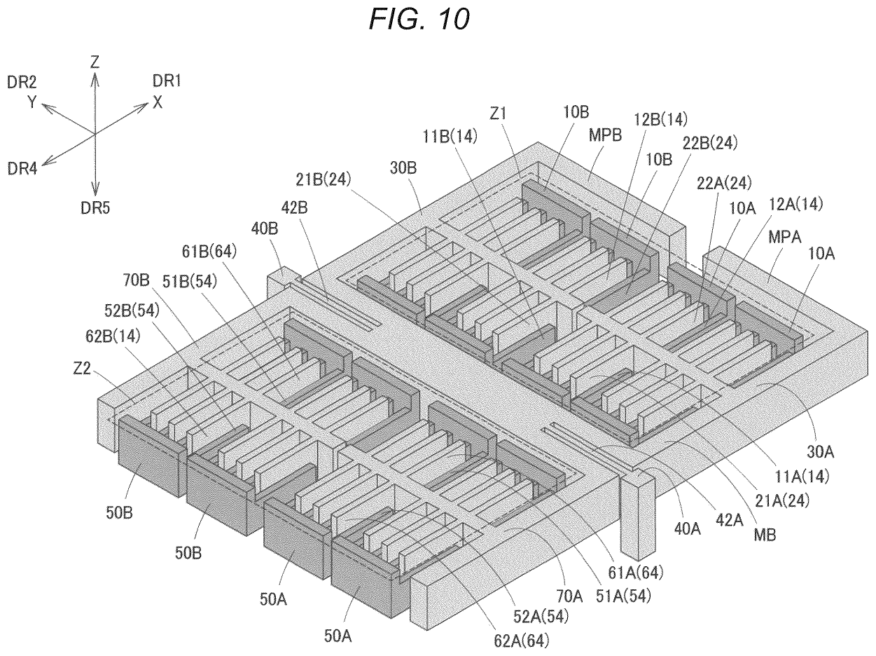

FIG. 10 is a perspective view of the first detailed example. In the first detailed example, in the probe electrode, similarly to the case in FIG. 3, the thickness of the first movable electrodes 21A and 22A and the third movable electrodes 21B and 22B in the third direction DR3 is larger than the thickness of the first fixed electrodes 11A and 12A and the third fixed electrodes 11B and 12B in the third direction DR3. The thickness of the second movable electrodes 61A and 62A and the fourth movable electrodes 61B and 62B in the third direction DR3 is larger than the thickness of the second fixed electrodes 51A and 52A and the fourth fixed electrodes 51B and 52B in the third direction DR3.

The probe electrode is formed by depositing a common electrode material and performing reactive ion etching (RIE) or the like thereon. Here, when providing an offset at a front surface of the electrode having a comb tooth shape in a plan view, in order to form a recessed shape of the offset, a resist is applied, exposure is performed by lithography, and an opening is machined, thereby forming the offset. Therefore, a configuration in which positions of front and back surfaces of the fixed electrodes and the movable electrodes are different on both sides sandwiching the rotation axis of the movable body MB requires an exposure process and the like, and is not desirable from the viewpoint of manufacturing cost and throughput. From the viewpoint of such a manufacturing process, in the embodiment, heights of the movable electrodes in the third direction DR3 are the same on either side of the support beams 42A and 42B serving as the rotation axis, and the front surfaces thereof are flush with each other. Accordingly, the number of manufacturing processes can be reduced, and the manufacturing cost can be reduced to the lowest.

In the embodiment, the physical quantity sensor 1 includes the third fixed electrode group 10B and the fourth fixed electrode group 50B. The movable body MB includes the third coupling portion 30B, the third base portion 23B, the third movable electrode group 20B, the fourth coupling portion 70B, the fourth base portion 63B, and the fourth movable electrode group 60B. The third coupling portion 30B is coupled to the other end of the support beam 42B and extends from the support beam 42B in the first direction DR1. The third base portion 23B is coupled to the third coupling portion 30B and is provided along the second direction DR2. The third movable electrode group 20B is provided at the third base portion 23B and faces the third fixed electrode group 10B in the second direction DR2. The fourth coupling portion 70B is coupled to the other end of the support beam 42B and extends from the support beam 42B in the fourth direction DR4. The fourth base portion 63B is coupled to the fourth coupling portion 70B and is provided along the second direction DR2. The fourth movable electrode group 60B is provided at the fourth base portion 63B and faces the fourth fixed electrode group 50B in the second direction DR2.

In this way, the front surfaces of the movable probe electrodes in the third direction DR3 can be made flush on either side of the support beams 42A and 42B serving as the rotation axis in the plan view. Accordingly, the manufacturing process can be simplified, and the manufacturing cost can be kept low.

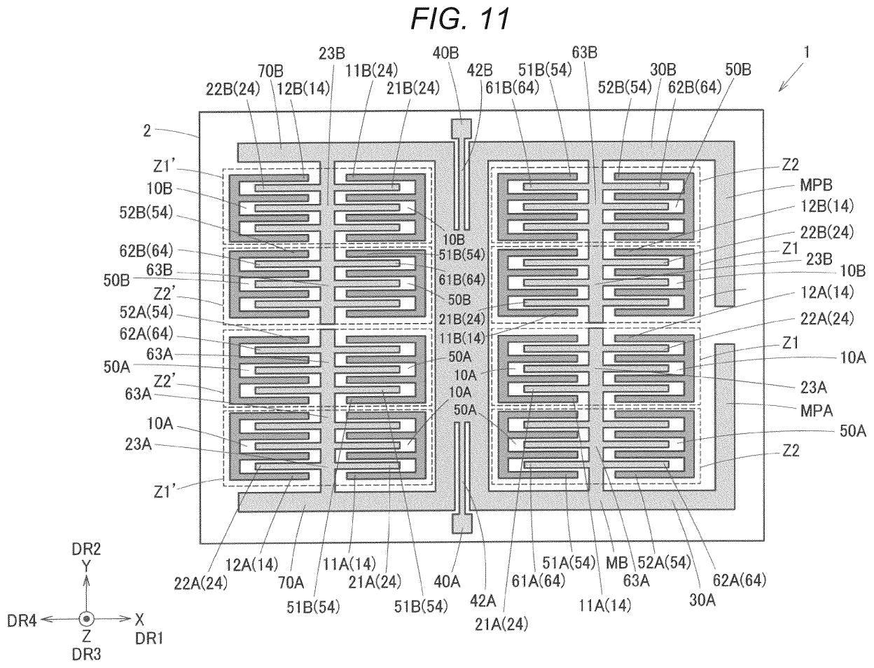

FIG. 11 is a plan view illustrating a second detailed example of the embodiment. An arrangement pattern of the detection parts Z1 and Z2 is different from that in the first detailed example. In the second detailed example, as illustrated in FIG. 11, the detection part Z1 and the detection part Z2 are provided at the first direction DR1 side of the support beams 42A and 42B serving as the rotation axis, and a detection part Z1′ and a detection part Z2′ are provided at the fourth direction DR4 side of the rotation axis. The detection parts Z1 and Z2′ are provided at symmetrical positions with respect to the rotation axis including the support beams 42A and 42B, and the detection parts Z2 and Z1′ are also provided at symmetrical positions with respect to the rotation axis. In the following description, the first movable electrodes 21A and 22A, the second movable electrodes 61A and 62A, the third movable electrodes 21B and 22B, and the fourth movable electrodes 61B and 62B are collectively referred to as movable electrodes as appropriate. Similarly, the first fixed electrodes 11A and 12A, the second fixed electrodes 51A and 52A, the third fixed electrodes 11B and 12B, and the fourth fixed electrodes 51B and 52B are collectively referred to as fixed electrodes as appropriate. These electrodes are collectively referred to as probe electrodes as appropriate.

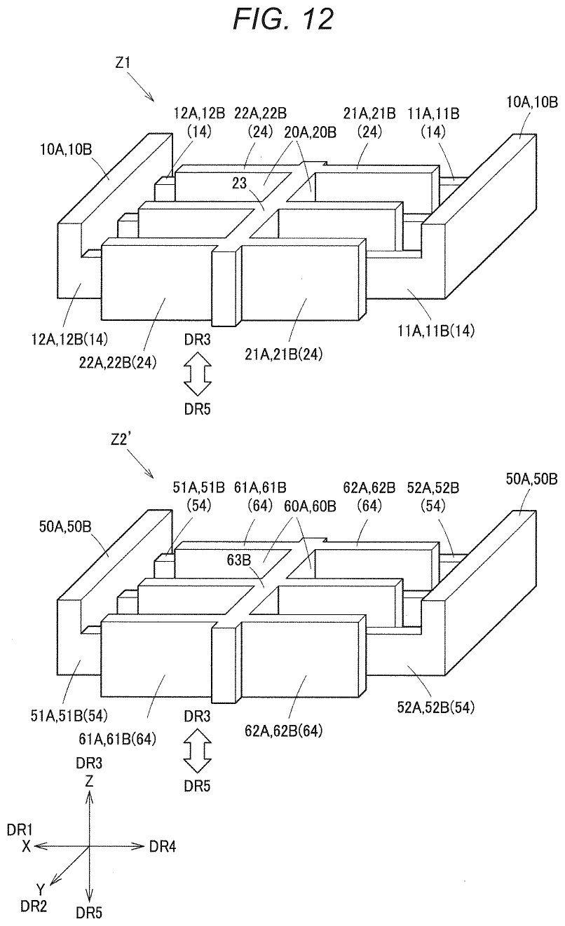

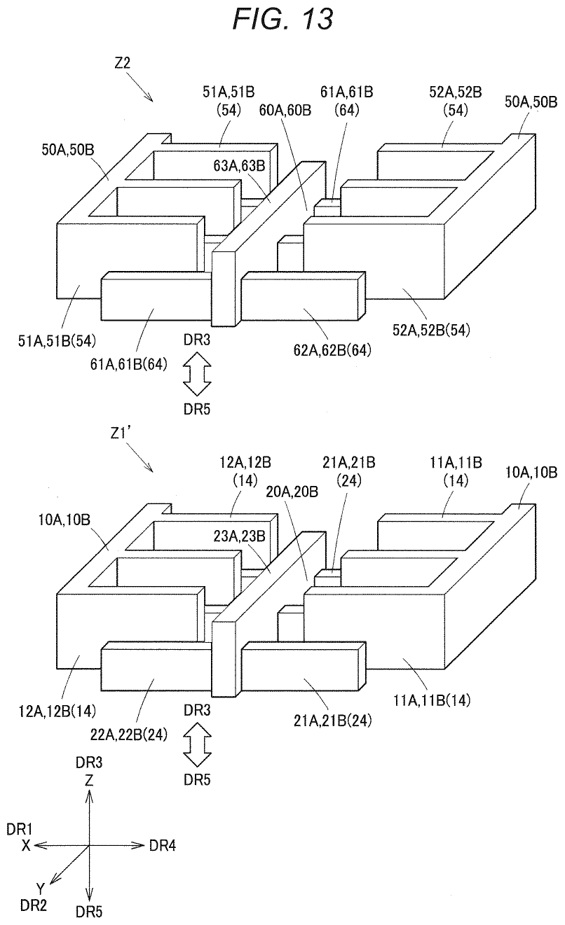

FIGS. 12 and 13 are perspective views illustrating shapes of the probe electrodes of the second detailed example. FIG. 12 illustrates the shapes of the probe electrodes of the detection parts Z1 and Z2′ provided symmetrically with respect to the support beams 42A and 42B serving as the rotation axis. In the detection part Z1 illustrated in the upper part of FIG. 12, a thickness of the first movable electrodes 21A and 22A and the third movable electrodes 21B and 22B in the third direction DR is larger than that of the first fixed electrodes 11A and 12A and the third fixed electrodes 11B and 12B in the third direction DR. In the detection part Z2′ illustrated in the lower part of FIG. 12, a thickness of the second movable electrodes 61A and 62A and the fourth movable electrodes 61B and 62B in the third direction DR is larger than that of the second fixed electrodes 51A and 52A and the fourth fixed electrodes 51B and 52B in the third direction DR3. In FIG. 12, the first fixed electrodes 11A and 12A and the third fixed electrodes 11B and 12B of the detection part Z1 illustrated in the upper part and the second fixed electrodes 51A and 52A and the fourth fixed electrodes 51B and 52B of the detection part Z2′ illustrated in the lower part have the same thickness in the third direction DR3. The first movable electrodes 21A and 22A and the third movable electrodes 21B and 22B of the detection part Z1 illustrated in the upper part and the second movable electrodes 61A and 62A and the fourth movable electrodes 61B and 62B of the detection part Z2′ illustrated in the lower part have the same thickness in the third direction DR3. As described above, on both sides of the rotation axis, the fixed electrodes have the same thickness, and the movable electrodes have the same thickness.

FIG. 13 illustrates the shapes of the probe electrodes of the detection part Z2 and the detection part Z1′ provided symmetrically with respect to the support beams 42A and 42B serving as the rotation axis. In the detection part Z2 illustrated in the upper part of FIG. 13, the thickness of the second movable electrodes 61A and 62A and the fourth movable electrodes 61B and 62B in the third direction DR is smaller than that of the second fixed electrodes 51A and 52A and the fourth fixed electrodes 51B and 52B in the third direction DR. In the detection part Z1′ illustrated in the lower part of FIG. 13, the thickness of the first movable electrodes 21A and 22A and the third movable electrodes 21B and 22B in the third direction DR is smaller than that of the first fixed electrodes 11A and 12A and the third fixed electrodes 11B and 12B in the third direction DR. In FIG. 13, the second fixed electrodes 51A and 52A and the fourth fixed electrodes 51B and 52B of the detection part Z2 illustrated in the upper part and the first fixed electrodes 11A and 12A and the third fixed electrodes 11B and 12B of the detector Z1′ illustrated in the lower part have the same thickness in the third direction DR3. The second movable electrodes 61A and 62A of the detection part Z2 illustrated in the upper part and the first movable electrodes 21A and 22A of the detection part Z1′ illustrated in the lower part have the same thickness in the third direction DR3. As described above, on both sides of the rotation axis, the fixed electrodes have the same thickness, and the movable electrodes have the same thickness.

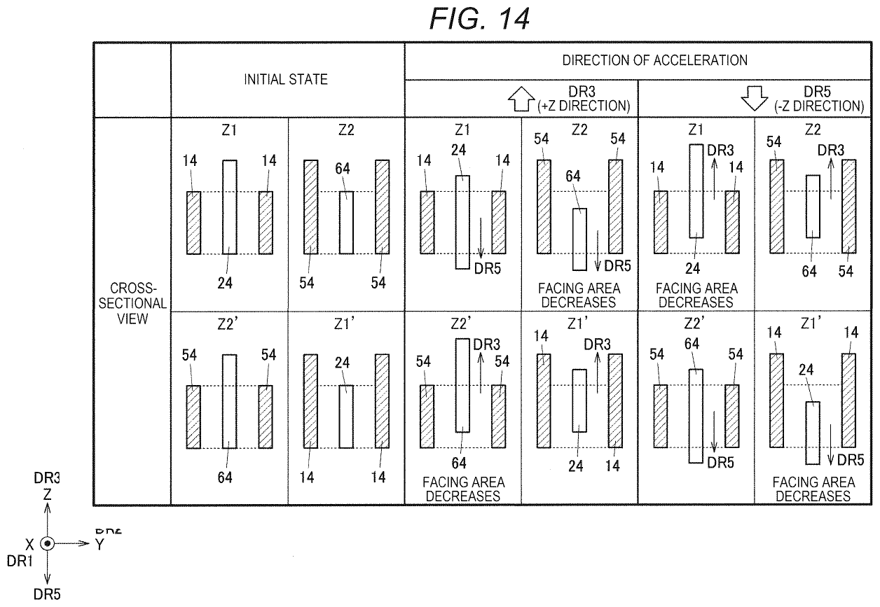

FIG. 14 is a diagram illustrating a method of detecting a physical quantity when the second detailed example is adopted. In the second detailed example, two detection parts are provided at each side of the support beams 42A and 42B serving as the rotation axis. Therefore, unlike the detection method illustrated in FIG. 4, it is necessary to consider the movement of each of the detection part Z1 and the detection part Z2′ and the detection part Z2 and the detection part Z1′, which are provided symmetrically with respect to the rotation axis, when an acceleration occurs.

First, in an initial state shown in a left part of FIG. 14, in a stationary state, positions of the probe electrodes of the detection parts on a back surface side are flush with each other. Next, a case where an acceleration in the third direction DR3 occurs is considered. As illustrated in a center column of FIG. 14, the detection part Z1 and the detection part Z2′ of the second detailed example can be considered to be similar to the detection parts Z1 and Z2 in the configuration example illustrated in FIG. 1 and the first detailed example, and have operations similar to the operations shown in the center column of FIG. 4. That is, a facing area of the probe electrodes facing each other in the detection part Z2′ provided at the fourth direction DR4 side of the rotation axis decreases. Regarding the detection part Z2 and the detection part Z1′, the thickness of the second movable electrode 64 and the first movable electrode 24 in the third direction DR3 is small, and a facing area decreases in the detection part Z2 provided at the first direction DR1 side of the rotation axis.

A case where an acceleration in the fifth direction DR5 occurs is considered. As illustrated in a right column of FIG. 14, the detection part Z1 and the detection part Z2′ can be considered to be similar to the detection parts Z1 and Z2 in the configuration example in FIG. 1 and the first detailed example, and have operations similar to the operations illustrated in the right column of FIG. 4. That is, a facing area of the probe electrodes facing each other in the detection part Z1 provided at the first direction DR1 side of the rotation axis decreases. Regarding the detection part Z2 and the detection part Z1′, a facing area decreases in the detection part Z1′ provided at the fourth direction DR4 side of the rotation axis.

The second detailed example is characterized in that areas having different thicknesses of the probe electrodes are arranged in a dispersed manner. In addition to the arrangement pattern in the configuration example illustrated in FIG. 11, various arrangement patterns can be selected. Here, by providing the detection parts so that the thicknesses of the probe electrodes are symmetrical with respect to the one-dot chain line indicated by a, it is possible to implement a configuration excellent in symmetry of the moment of inertia around the support beams 42A and 42B serving as the rotation axis. This contributes to stabilization of the seesaw movement of the movable body MB.

In the embodiment, the first movable electrode group 20A and the third movable electrode group 20B have different thicknesses in the third direction DR3, and the second movable electrode group 60A and the fourth movable electrode group 60B have different thicknesses in the third direction DR3.

In this way, when providing the detection parts in which the probe electrodes have different thicknesses in the third direction DR3, various arrangement patterns can be selected.

In the configuration example in FIG. 1, the first detailed example, and the second detailed example described above, the case where the positions of the comb tooth electrodes are flush with each other at the back surface side of the probe electrodes is described. Alternatively, the positions of the comb tooth electrodes may be flush with each other at a front surface side.

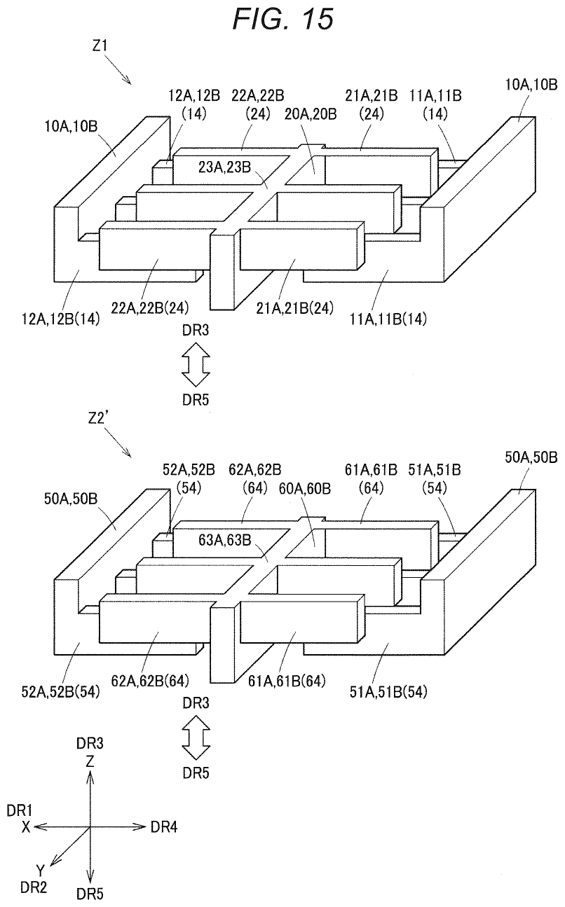

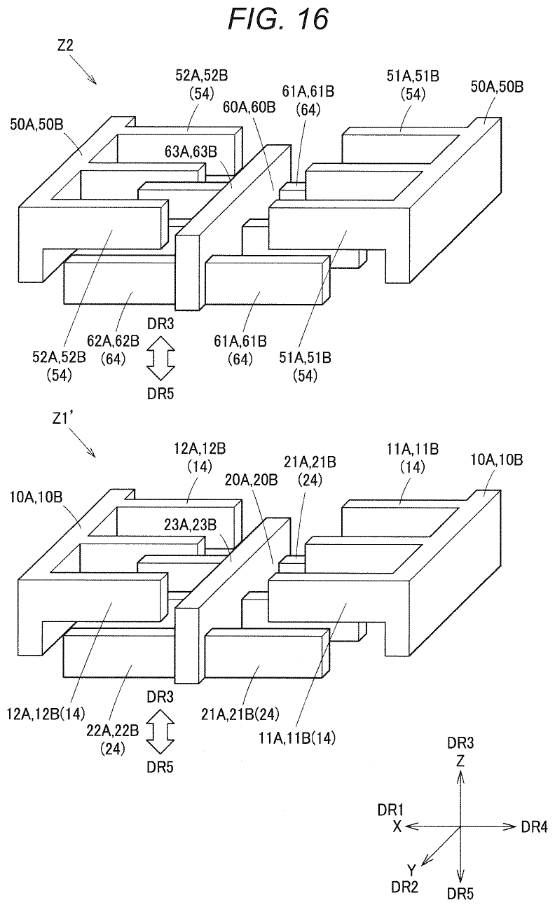

Next, a third detailed example will be described. The third detailed example is an embodiment in which the configuration of the probe electrodes in the second detailed example is changed to have a two-side offset shape. FIGS. 15 and 16 are perspective views of probe electrodes in the third detailed example. With respect to an arrangement pattern of detection parts, the third detailed example has the same configuration as the second detailed example. In the configuration example in FIG. 1, the first detailed example, and the second detailed example described above, the one-side offset structure is implemented in which the offset shape is provided at the front surface side of the probe electrodes. In this regard, the third detailed example has a two-side offset structure in which a probe electrode has an offset shape at each of a front surface and a back surface of the probe electrode in a cross-sectional view.

FIG. 15 illustrates a perspective view of probe electrodes of the detection parts Z1 and Z2′. That is, in the third detailed example, shapes of the probe electrodes of the detection parts Z1 and Z2′ provided symmetrically with respect to the rotation axis of the movable body MB are shown. An upper part of FIG. 15 shows the probe electrodes of the detection part Z1 provided at the first direction DR1 side of the rotation axis, and a lower part shows the probe electrodes of the detection part Z2′ provided at the fourth direction DR4 side of the rotation axis.

Comparing the upper part of FIG. 15 with the lower part thereof, at a front surface side of each detection part, movable electrodes are located at the third direction DR3 side with respect to fixed electrodes, and an offset shape is formed. At a back surface side of each detection part, the fixed electrodes are located at the fifth direction DR5 side with respect to the movable electrodes, and an offset shape is formed. The fixed electrodes and the movable electrodes have the same thickness in the third direction DR3.

FIG. 16 illustrates a perspective view of probe electrodes of the detection part Z2 and the detection part Z1′. As illustrated in FIG. 11, the detection part Z2 and Z1′ are provided symmetrically with respect to the support beams 42A and 42B serving as the rotation axis. An upper part of FIG. 16 shows the probe electrodes of the detection part Z2 provided at the first direction DR1 side of the rotation axis, and a lower part shows the probe electrodes of the detector Z1′ provided at the fourth direction DR4 side of the rotation axis. Comparing the upper part of FIG. 16 and the lower part thereof, at a front surface side of each detection part, fixed electrodes are located at the third direction DR3 side with respect to movable electrodes, and an offset shape is formed. At a back surface side of each detection part, the movable electrodes are located at the fifth direction DR5 side with respect to the fixed electrodes, and an offset shape is formed. The probe electrodes have the same thickness in the third direction DR3.

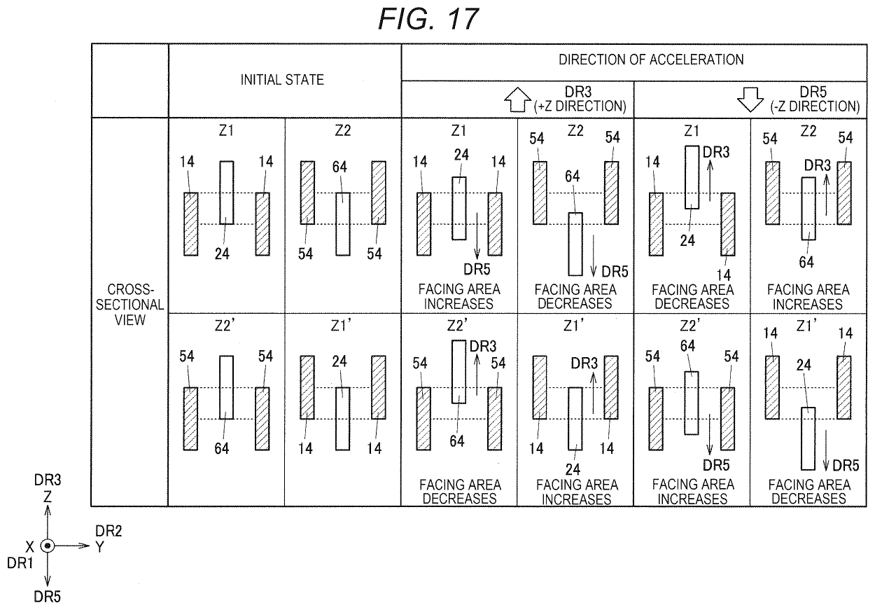

FIG. 17 is a diagram illustrating operations of the third detailed example. The third detailed example is the same as the second detailed example in the arrangement pattern of the detection parts, and is different from the second detailed example in having the two-side offset structure for the probe electrodes. Therefore, a basic movement of each probe electrode when an acceleration occurs from an initial state is similar to that in the second detailed example illustrated in FIG. 14. However, due to the two-side offset structure, a change appears in the facing area of the facing probe electrodes in all detection parts. For example, as illustrated in a center column of FIG. 17, when an acceleration in the third direction DR3 occurs, the facing area of the facing probe electrodes decreases in the detection part Z2′, and the facing area increases in the detection part Z1. In the detection part Z2, the facing area of the facing probe electrodes decreases, and in the detection part Z1′, the facing area increases. As described above, in the second detailed example, when the acceleration in the third direction DR3 occurs, the facing area of the facing probe electrodes in the detection parts Z1 and Z1′ does not change, whereas in the third detailed example, the facing area of the facing probe electrodes in the detection parts Z1 and Z1′ increases. As illustrated in a right column of FIG. 17, when an acceleration in the fifth direction DR5 occurs, the facing area of the facing probe electrodes decreases in the detection part Z1′, and the facing area increases in the detection part Z2′. In the detection part Z1′, the facing area of the facing probe electrodes decreases, and in the detection part Z2, the facing area increases. As described above, in the third detailed example, the facing area of the facing probe electrodes changes in all detection parts.

According to the third detailed example, for example, with respect to the acceleration in the third direction DR3, since the change in the facing area of the facing probe electrodes is detected in any of the detection parts, detection sensitivity of a physical quantity can be increased as compared with the configuration example in FIG. 1, the first detailed example, and the second detailed example.

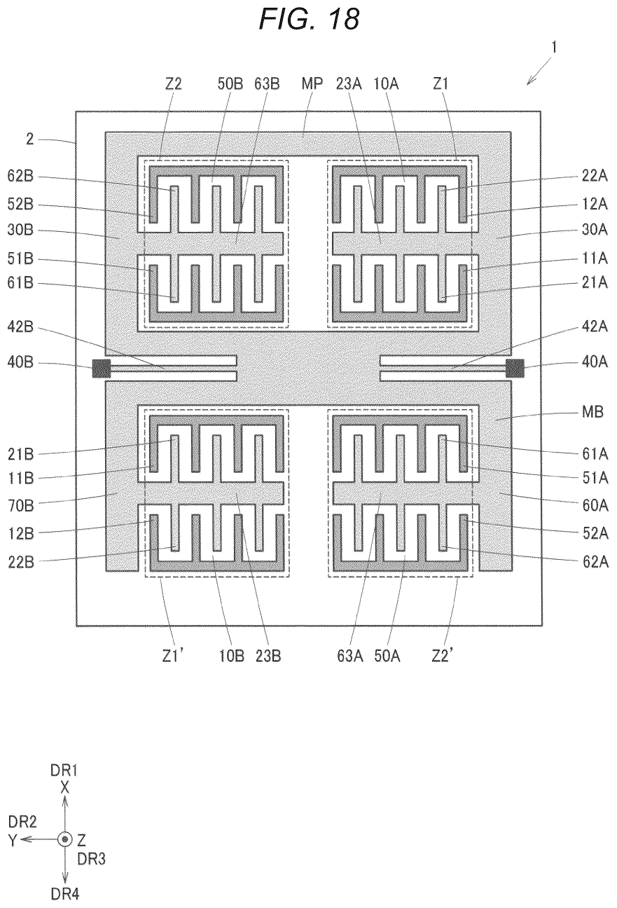

FIG. 18 illustrates a first modification of the first detailed example, the second detailed example, and the third detailed example. Configurations of the mass portions MPA and MPB are different from those of the first detailed example and the like. Specifically, in the first modification, a tip end of the mass portion MPA and a tip end of the mass portion MPB are coupled and integrated.

As illustrated in FIG. 18, even when the configuration in which the mass portion MPA and the mass portion MPB are integrated is adopted, an electrode wiring is not affected. Therefore, according to the first modification, by coupling the mass portion MPA and the mass portion MPB, deformation of the entire movable body MB is less likely to occur, rigidity of the movable body MB can be improved, a moment of inertia around the rotation axis can be increased, and detection sensitivity of a physical quantity can be improved.

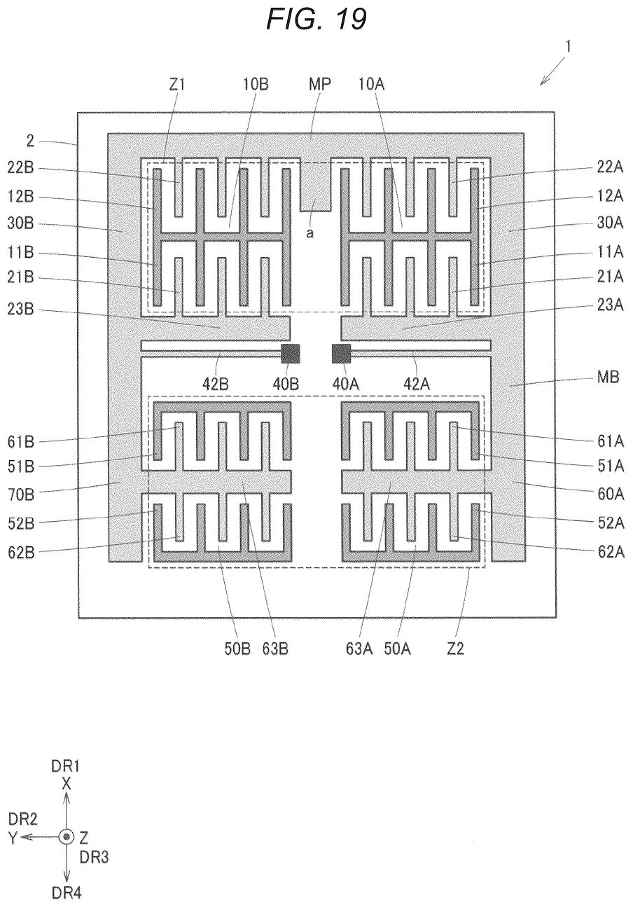

FIG. 19 illustrates a second modification of the first detailed example, the second detailed example, and the third detailed example. The second modification is different from the first detailed example in that the fixed portions 40A and 40B, which correspond to anchors in the seesaw movement of the movable body MB, are located at an inner side. As described above, by locating the fixed portions 40A and 40B close to an inside of the movable body MB in a plan view, influence of warpage of the substrate 2 is less likely to be received, and influence of a change in temperature is less likely to be received. Accordingly, the physical quantity sensor 1 can have improved detection accuracy of a physical quantity. In addition, in the second modification, a configuration in which the mass portion MPA and the mass portion MPB are integrated similarly to the first modification is adopted for the mass portion MP, and a protrusion indicated by a in FIG. 19 is provided. By providing such a protrusion, a moment of inertia around the rotation axis of the movable body MB can be increased, and detection sensitivity of the physical quantity can be improved.

### 3. Inertial Measurement Unit

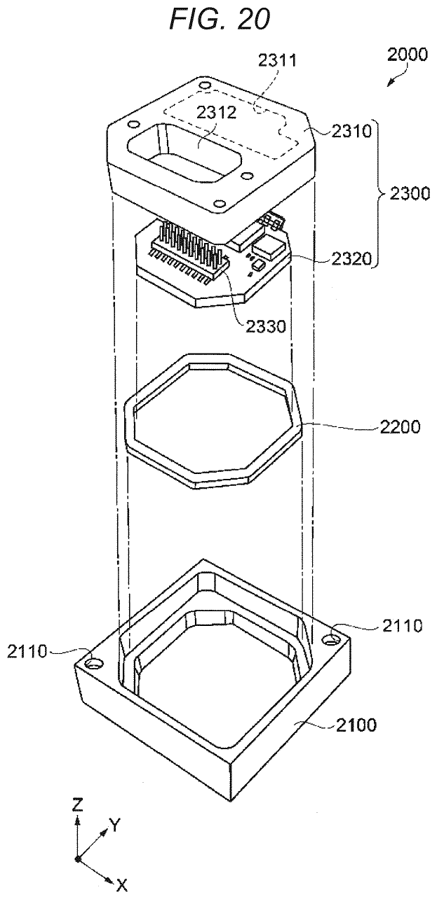

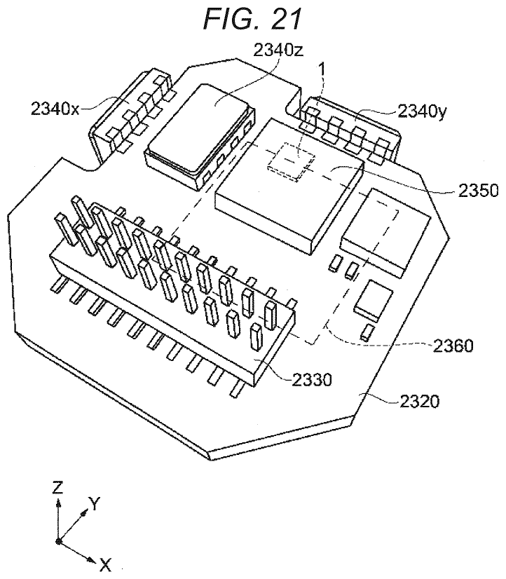

Next, an example of an inertial measurement unit 2000 according to the embodiment will be described with reference to FIGS. 20 and 21. The inertial measurement unit (IMU) 2000 illustrated in FIG. 20 is a unit that detects an inertial motion amount of a posture, an action or the like of a moving body such as an automobile or a robot. The inertial measurement unit 2000 is a so-called six-axis motion sensor including an acceleration sensor that detects accelerations ax, ay, and az in directions along three axes and an angular velocity sensor that detects angular velocities ωx, ωy, and ωz around the three axes.

The inertial measurement unit 2000 is a rectangular parallelepiped having a substantially square planar shape. Screw holes 2110 as mount portions are formed in the vicinity of two vertexes positioned in a diagonal direction of the square. Two screws can be passed through the two screw holes 2110 to fix the inertial measurement unit 2000 to a mounted surface of a mounted body such as an automobile. By component selection or design change, for example, it is also possible to reduce a size of the inertial measurement unit 2000 to such a degree that allows the inertial measurement unit 2000 to be mounted on a smartphone or a digital camera.

The inertial measurement unit 2000 includes an outer case 2100, a bonding member 2200, and a sensor module 2300, and has a configuration in which the sensor module 2300 is inserted inside the outer case 2100 with the bonding member 2200 interposed therebetween. The sensor module 2300 includes an inner case 2310 and a circuit board 2320. The inner case 2310 is formed with a recess 2311 for preventing contact with the circuit board 2320 and an opening 2312 for exposing a connector 2330 to be described later. Further, the circuit board 2320 is bonded to a lower surface of the inner case 2310 via an adhesive.

As illustrated in FIG. 21, the connector 2330, an angular velocity sensor 2340z that detects an angular velocity around the Z axis, an acceleration sensor unit 2350 that detects an acceleration in each axial direction of the X axis, the Y axis, and the Z axis, and the like are mounted at an upper surface of the circuit board 2320. Further, an angular velocity sensor 2340x that detects an angular velocity around the X axis and an angular velocity sensor 2340y that detects an angular velocity around the Y axis are mounted at side surfaces of the circuit board 2320.

The acceleration sensor unit 2350 includes at least the physical quantity sensor 1 for measuring the acceleration in the Z-axis direction described above, and can detect an acceleration in one axial direction or an acceleration in two axial directions or three axial directions as necessary. The angular velocity sensors 2340x, 2340y, and 2340z are not particularly limited, and for example, a vibration gyro sensor using the Coriolis force can be used.

Further, a control IC 2360 is mounted at a lower surface of the circuit board 2320. The control IC 2360 serving as a control unit that performs control based on a detection signal output from the physical quantity sensor 1 is, for example, a micro controller unit (MCU), includes a storage unit including a nonvolatile memory, an A/D converter, and the like therein, and controls each unit of the inertial measurement unit 2000. In addition, a plurality of electronic components are mounted at the circuit board 2320.

As described above, the inertial measurement unit 2000 according to the embodiment includes the physical quantity sensor 1 and the control IC 2360 serving as the control unit that performs the control based on the detection signal output from the physical quantity sensor 1. According to the inertial measurement unit 2000, since the acceleration sensor unit 2350 including the physical quantity sensor 1 is used, an effect of the physical quantity sensor 1 can be enjoyed, and the inertial measurement unit 2000 capable of implementing high accuracy and the like can be provided.

The inertial measurement unit 2000 is not limited to the configuration illustrated in FIGS. 20 and 21. For example, the inertial measurement unit 2000 may have a configuration in which only the physical quantity sensor 1 is provided as the inertial sensor without providing the angular velocity sensors 2340x, 2340y, and 2340z. In this case, for example, the inertial measurement unit 2000 may be implemented by accommodating the physical quantity sensor 1 and the control IC 2360 implementing the control unit in a package that is an accommodating container.

As described above, a physical quantity sensor of the embodiment includes a fixed portion, a support beam, a movable body, a first fixed electrode group, and a second fixed electrode group. The fixed portion is fixed to a substrate, the support beam has one end coupled to the fixed portion and is provided along a second direction, and the movable body is coupled to the other end of the support beam. The first fixed electrode group is provided at the substrate and disposed in a first direction of the support beam, and the second fixed electrode group is provided at the substrate and disposed in a fourth direction opposite to the first direction of the support beam. The movable body includes a first coupling portion, a first base portion, a first movable electrode group, a second coupling portion, a second base portion, a second movable electrode group, and a mass portion. The first coupling portion is coupled to the other end of the support beam and extends in the first direction from the support beam. The first base portion is coupled to the first coupling portion and is provided along the second direction. The first movable electrode group is provided at the first base portion and faces the first fixed electrode group in the second direction. The second coupling portion is coupled to the other end of the support beam and extends in the fourth direction from the support beam. The second base portion is coupled to the second coupling portion and is provided along the second direction. The second movable electrode group is provided at the second base portion and faces the second fixed electrode group in the second direction. The mass portion is coupled to the first coupling portion and is provided at the first direction side of the first movable electrode group.

According to the embodiment, with respect to an acceleration in a third direction, the support beam is twisted, and thus the movable body can perform a swing movement with the support beam as a rotation axis. Due to the swing movement of the movable body, a facing area of the first fixed electrode group and the first movable electrode group changes, and a facing area of the second fixed electrode group and the second movable electrode group also changes. Accordingly, a change in a physical quantity can be detected based on the change in the facing area of the probe electrodes.

In the embodiment, the support beam is a torsion spring that is twisted with the second direction as a rotation axis.

In this way, the movable body can perform the swing movement with the second direction as a rotation axis.

In the embodiment, hm=hr, where hm is a height of a gravity center position of the movable body in the third direction and hr is a height of a rotation center of the support beam in the third direction.

In this way, the height hm of the gravity center position of the movable body is equal to the height hr of the gravity center position of the support beam. Therefore, with respect to physical quantities in the first direction and the fourth direction other than the third direction, a torque that moves the movable body in the third direction is not generated. Accordingly, sensitivity in other axial directions of a physical quantity sensor is reduced, and the physical quantity can be detected with high accuracy.

In the embodiment, thicknesses of the first movable electrode group and the second movable electrode group in the third direction are equal to a thickness of the support beam in the third direction.

In this way, since the thicknesses of the first movable electrode group and the second movable electrode group in the third direction are equal to each other, it is simplified to form these electrodes by batch processing in the same machining process.

In the embodiment, thicknesses of the first base portion, the second base portion, the first coupling portion, and the second coupling portion in the third direction are equal to the thickness of the support beam in the third direction.

In this way, the height hr of the rotation center of the support beam in the third direction can be made equal to the height hm of the gravity center position of the movable body in the third direction. Therefore, a position vector from the support beam, which is the rotation axis of the movable body, to the gravity center position of the movable body can be made horizontal. Accordingly, when accelerations in the first direction and the fourth direction other than the third direction occur, the movable body can be prevented from swinging with the support beam as the rotation axis. In this case, although the movable body does not swing but is displaced in the first and fourth directions, the change in the facing area can be cancelled out in each detection part, and thus the detection accuracy can be improved.

Further, in the embodiment, the thickness of the first movable electrode group in the third direction is larger than the thickness of the first fixed electrode group in the third direction, and the thickness of the second movable electrode group in the third direction is larger than the thickness of the second fixed electrode group in the third direction.

In this way, when an acceleration in the third direction occurs, the facing area of the first fixed electrode group and the first movable electrode group is maintained, and the facing area of the second fixed electrode group and the second movable electrode group decreases, and accordingly a change in a physical quantity in the third direction can be detected. Further, when an acceleration in a fifth direction occurs, the facing area of the second fixed electrode group and the second movable electrode group is maintained, and the facing area of the first fixed electrode group and the first movable electrode group is reduced, and accordingly a change in a physical quantity in the fifth direction can be detected.

In the embodiment, the thickness of the first movable electrode group in the third direction is smaller than the thickness of the first fixed electrode group in the third direction, and the thickness of the second movable electrode group in the third direction is smaller than the thickness of the second fixed electrode group in the third direction.

In this way, when an acceleration in the third direction occurs, the facing area of the second fixed electrode group and the second movable electrode group is maintained, and the facing area of the first fixed electrode group and the first movable electrode group decreases, and accordingly a change in a physical quantity in the third direction can be detected. In addition, when an acceleration in the fifth direction occurs, the facing area of the first fixed electrode group and the first movable electrode group is maintained, and the facing area of the second fixed electrode group and the second movable electrode group decreases, and accordingly a change in a physical quantity in the fifth direction can be detected.

In the embodiment, positions of the first movable electrode group and the first fixed electrode group on a back surface side coincide with each other in an initial state, and positions of the second movable electrode group and the second fixed electrode group on the back surface side coincide with each other in the initial state.

In this way, after electrode materials of the first movable electrode group, the first fixed electrode group, the second movable electrode group, and the second fixed electrode group are deposited, comb tooth electrodes can be collectively formed by the same machining process, and the manufacturing process is simplified.

That is, in the embodiment, the physical quantity sensor includes a third fixed electrode group and a fourth fixed electrode group. The movable body includes a third coupling portion, a third base portion, a third movable electrode group, a fourth coupling portion, a fourth base portion, and a fourth movable electrode group. The third coupling portion is coupled to the other end of the support beam and extends in the first direction from the support beam. The third base portion is coupled to the third coupling portion and is provided along the second direction. The third movable electrode group is provided at the third base portion and faces the third fixed electrode group in the second direction. The fourth coupling portion is coupled to the other end of the support beam and extends in the fourth direction from the support beam. The fourth base portion is coupled to the fourth coupling portion and is provided along the second direction. The fourth movable electrode group is provided at the fourth base portion and faces the fourth fixed electrode group in the second direction.

In this way, front surfaces of the movable probe electrodes in the third direction can be made flush at both sides of the support beam serving as the rotation axis in a plan view, and the manufacturing process can be simplified.

In the embodiment, the first movable electrode group and the third movable electrode group have different thicknesses in the third direction, and the second movable electrode group and the fourth movable electrode group have different thicknesses in the third direction.

In this way, when providing the detection part in which the probe electrodes have different thicknesses in the third direction, various arrangement patterns can be selected.

The embodiment relates to an inertial measurement unit including a control unit configured to perform control based on a detection signal output from the physical quantity sensor.

Although the embodiments have been described in detail as described above, it can be readily apparent to those skilled in the art that various modifications may be made without departing substantially from novel matters and effects of the present disclosure. Accordingly, such modifications are intended to be included in the scope of the present disclosure. For example, a term cited with a different term having a broader meaning or the same meaning at least once in the description or in the drawings can be replaced with the different term at any place in the description or in the drawings. In addition, all combinations of the embodiments and the modifications are also included in the scope of the present disclosure. The configurations, operations, and the like of the physical quantity sensor and the inertial measurement unit are not limited to those described in the embodiments, and various modifications can be made.

What is claimed is:

1. A physical quantity sensor which, when three directions orthogonal to one another are defined as a first direction, a second direction, and a third direction, detects a physical quantity in the third direction, the physical quantity sensor comprising:
a fixed portion fixed to a substrate;
a support beam having one end coupled to the fixed portion and provided along the second direction;
a movable body coupled to the other end of the support beam;
a first fixed electrode group provided at the substrate and disposed in the first direction of the support beam; and
a second fixed electrode group provided at the substrate and disposed in a fourth direction opposite to the first direction of the support beam,
wherein the movable body includes
a first coupling portion coupled to the other end of the support beam and extending from the support beam in the first direction,
a first base portion coupled to the first coupling portion and provided along the second direction,
a first movable electrode group provided at the first base portion and facing the first fixed electrode group in the second direction,
a second coupling portion coupled to the other end of the support beam and extending from the support beam in the fourth direction,
a second base portion coupled to the second coupling portion and provided along the second direction,
a second movable electrode group provided at the second base portion and facing the second fixed electrode group in the second direction, and
a mass portion coupled to the first coupling portion and provided at a first direction side of the first movable electrode group.

2. The physical quantity sensor according to claim 1, wherein
at the first direction side of the first movable electrode group, the mass portion extends along the second direction from the first coupling portion.

3. The physical quantity sensor according to claim 1, wherein
hm=hr, where hm is a height of a gravity center position of the movable body in the third direction and hr is a height of a rotation center of the support beam in the third direction.

4. The physical quantity sensor according to claim 1, wherein
thicknesses of the first movable electrode group and the second movable electrode group in the third direction are equal to a thickness of the support beam in the third direction.

5. The physical quantity sensor according to claim 4, wherein
thicknesses of the first base portion, the second base portion, the first coupling portion, and the second coupling portion in the third direction are equal to the thickness of the support beam in the third direction.

6. The physical quantity sensor according to claim 1, wherein
a thickness of the first movable electrode group in the third direction is larger than a thickness of the first fixed electrode group in the third direction, and
a thickness of the second movable electrode group in the third direction is larger than a thickness of the second fixed electrode group in the third direction.

7. The physical quantity sensor according to claim 1, wherein
a thickness of the first movable electrode group in the third direction is smaller than a thickness of the first fixed electrode group in the third direction, and
a thickness of the second movable electrode group in the third direction is smaller than a thickness of the second fixed electrode group in the third direction.

8. The physical quantity sensor according to claim 6, wherein
positions of the first movable electrode group and the first fixed electrode group on a back surface side coincide with each other in an initial state, and positions of the second movable electrode group and the second fixed electrode group on the back surface side coincide with each other in the initial state.

9. The physical quantity sensor according to claim 1, further comprising:
a third fixed electrode group and a fourth fixed electrode group,
wherein the movable body includes
a third coupling portion coupled to the other end of the support beam and extending from the support beam in the first direction,
a third base portion coupled to the third coupling portion and provided along the second direction,
a third movable electrode group provided at the third base portion and facing the third fixed electrode group in the second direction,
a fourth coupling portion coupled to the other end of the support beam and extending from the support beam in the fourth direction,
a fourth base portion coupled to the fourth coupling portion and provided along the second direction, and
a fourth movable electrode group provided at the fourth base portion and facing the fourth fixed electrode group in the second direction.

10. The physical quantity sensor according to claim 9, wherein
the first movable electrode group and the third movable electrode group have different thicknesses in the third direction, and
the second movable electrode group and the fourth movable electrode group have different thicknesses in the third direction.

11. The physical quantity sensor according to claim 1, wherein
the support beam is a torsion spring that is twisted with the second direction as a rotation axis.

12. An inertial measurement unit comprising:
the physical quantity sensor according to claim 1; and
a control unit configured to perform control based on a detection signal output from the physical quantity sensor.
